(19) United States
(12) Patent Application Publication
(10) Pub. No.: US 2025/0276279 A1
(43) Pub. Date: Sep. 4, 2025

(54) SORBENT COATED CARBON FIBERS AND THEIR MODULES FOR REDUCING CARBON DIOXIDE USING ELECTRICALLY DRIVEN TEMPERATURE SWING ADSORPTION SYSTEM

(71) Applicant: Georgia Tech Research Corporation, Atlanta, GA (US)

(72) Inventors: Ryan P. Lively, Atlanta, GA (US); Sayan Banerjee, Fremont, CA (US); Christopher W. Jones, Atlanta, CA (US); Won Hea Lee, Atlanta, GA (US); Matthew J. Realff, Atlanta, GA (US); Xin Zhang, Atlanta, GA (US)

(21) Appl. No.: 19/190,141

(22) Filed: Apr. 25, 2025

Related U.S. Application Data
(63) Continuation of application No. PCT/US2023/077977, filed on Oct. 26, 2023.
(60) Provisional application No. 63/381,215, filed on Oct. 27, 2022.

(51) Int. Cl. B01D 53/62; B01D 53/04; B01J 20/26; B01J 20/32

(52) U.S. Cl. CPC B01D 53/62; B01D 53/0462; B01J 20/26; B01J 20/3204; B01D 2253/102; B01D 2253/202; B01D 2253/25; B01D 2257/504; B01D 2259/40007; B01D 2259/40013

(57) ABSTRACT

The present disclosure relates to relates to sorbent coated carbon fibers, modules containing the same, and their use in reducing carbon dioxide levels via direct air capture.

### CROSS REFERENCE TO RELATED APPLICATION

This application claims the benefit of U.S. Provisional Application No. 63/381,215 filed on Oct. 27, 2022.

### STATEMENT REGARDING FEDERALLY SPONSORED RESEARCH OR DEVELOPMENT

This invention was made with Government support under contract DE-AR 0001414 awarded by the Advanced Research Projects Agency-Energy of the U.S. Department of Energy. The Government has certain rights in this invention.

### FIELD OF THE INVENTION

The present invention relates to sorbent coated carbon fibers, modules containing the same, and their use in reducing carbon dioxide levels via direct air capture.

### BACKGROUND OF THE INVENTION

Direct air capture (DAC) technologies, which extract CO₂ directly from the air, have received significant attention as a major component in global strategies to mitigate the worst effects of climate change. A variety of DAC processes have been proposed, with many of the major designs focusing on the use of adsorption-based systems. These systems typically utilize temperature swing adsorption (TSA) cycles with vacuum-assisted or steam-driven desorption systems. The usage of direct or indirect steaming incurs complications with auxiliary equipment as well as water management before and after exposure of steam to the adsorbents.

Electrically-driven temperature swing adsorption (ETSA) is an emerging technology for CO₂ adsorption to improve the energy efficiency and productivity of TSA as electric heat is directly delivered to the adsorbent. In the ETSA system, a purge gas flow is controlled independently of the heating rate, and higher concentrations of recovered adsorbate can be reached. Ideally, no purge gas would be used such that a pure CO₂ product may be collected, but this has not been demonstrated in ETSA experiments to date. ETSA is expected to have much higher heat transfer rates than indirect heating methods (e.g., external heating with resistance heaters, steam, etc.) and potentially heat transfer rates that are comparable to direct steaming of the adsorbent. These high heating rates, in addition to obviating the need for auxiliary water heaters and treatment systems, suggest that ETSA systems may enable smaller DAC systems than traditional TSA processes.

Joule heating is straightforward way to convert electric current to thermal energy. Carbon or carbonaceous materials have shown good Joule heating properties due to their appropriate electrical properties, and these can be renewably sourced, unlike some other materials that might be used for Joule heating. Many types of carbonaceous materials have been investigated for ETSA in fibrous or monolithic contactors since these types of architectures enable both rapid mass transfer and electrically-driven heat transfer. For example, poly(ethyleneimine) (PEI) functionalized silicon carbide or carbon nanotube-zeolite hollow fibers have been fabricated by pyrolysis and operated an ETSA cycle on the fibers for post-combustion CO₂ capture applications. Activated carbon fibers have been made from carbon fiber and phenolic resin and used them for the electrothermal desorption of CO₂ and volatile organic compounds. 3D printed activated carbon monoliths have also been prepared using carbon paste and then evaluated the ESA performance of the monoliths for biogas upgrade (CO₂/CH₄, 40/60 vol %/vol %). However, one common theme among these strategies is a generally low CO₂ capacity for the carbonaceous materials, with <0.6 mmol/gₜₒₜₐₗ total uptakes typically observed under concentrated CO₂ conditions (˜40%), which is estimated to lead to <0.3 mmol/gₜₒₜₐₗ under DAC conditions. Moreover, to the best of our knowledge, there are no reports of ETSA systems for DAC applications.

There is therefore a need for new materials and methods useful for directly extracting CO₂ from the air.

### SUMMARY OF THE INVENTION

The present invention provides a direct air capture (DAC) modules and wind energy direct air capture (WEDAC) modules that are rationally devised with sorbent-coated carbon fibers to capture CO₂ from the surrounding environment, which can be an ambient room temperature (e.g., 20-22° C.) or an environmental temperature above or below room temperature. Sorbent-coated carbon fibers according to the invention exhibit the Joule effect, quickly responding to the electrical signal and therefore rapid CO₂ regeneration. An electrically-driven temperature swing adsorption operated by the Joule heating modules presents a new direction of direct air capture.

Herein, we describe the preparation of sorbent-coated carbon fibers via roll-to-roll coating followed by poly(ethyleneimine) (PEI) impregnation, and their modules. The fibers exhibit Joule heating upon application of a potential, reaching a common CO₂ desorption temperature (˜110° C.) within a minute, after CO₂ adsorption of ˜1.2 mmol/g_{fiber} under 400 ppm CO₂. The ETSA performance of the fiber modules is evaluated under simulated air atmosphere with 400 ppm CO₂. The modules show rapid CO₂ regeneration by electrothermal desorption after 7 V directly is applied to the carbon fibers, releasing ˜95% of adsorbed CO₂ six times faster than externally-driven thermal desorption. The simplicity and modularity of the sorbent-coated carbon fibers, based on commercially-available materials, and their rapid adsorption/desorption cycling by ETSA have the potential to improve the productivity of DAC systems relative to traditional temperature swing adsorption processes.

In one or more non-limiting embodiments, the present invention provides sorbent-coated carbon fibers prepared via roll-to-roll coating and PEI impregnation. In one or more non-limiting embodiments, the present invention provides sorbent-coated carbon fibers that exhibit Joule heating and rapid temperature swing. In one or more non-limiting embodiments, the present invention provides fiber modules that exhibit about 0.30- about 0.88 mmol g_{fiber}⁻¹ breakthrough capacities with 400 ppm CO₂. In one or more non-limiting embodiments, the present invention provides modules in which sorbed CO₂ is desorbed (˜95%) in less than 10 minutes by rapid electrothermal desorption.

In some instances, a first aspect of the disclosure can be described as a carbon dioxide (CO₂) capture material, the material comprising a carbon-containing fiber, and a CO₂ adsorptive material coating the carbon-containing fiber.

In some instances, a second aspect of the disclosure can be described as a carbon dioxide (CO₂) capture material according to the first aspect, wherein the carbon-containing fiber is a carbon fiber.

In some instances, a third aspect of the disclosure can be described as a carbon dioxide (CO₂) capture material according to the second aspect, wherein the carbon fiber is a polymer-derived (e.g., polyacrylonitrile, PAN) carbon fiber, an activated carbon fiber, a multi-walled carbon nanotube fiber, a single-walled carbon nanotube fiber, or a silicon carbide fiber.

In some instances, a fourth aspect of the disclosure can be described as a carbon dioxide (CO₂) capture material according to any one of the first through third aspects, wherein the CO₂ adsorptive material comprises a porous support and an adsorbent material.

In some instances, a fifth aspect of the disclosure can be described as a carbon dioxide (CO₂) capture material according to the fourth aspect, wherein the porous support is mesoporous.

In some instances, a sixth aspect of the disclosure can be described as a carbon dioxide (CO₂) capture material according to the fourth aspect, wherein the porous support is a porous silica, a porous alumina, a porous aluminosilicate, a metal-organic framework, a zeolite, a zeolitic imidazole framework, or a covalent organic framework.

In some instances, a seventh aspect of the disclosure can be described as a carbon dioxide (CO₂) capture material according to any one of the fourth through sixth aspects, wherein the adsorbent material is an amine-based adsorbent.

In some instances, an eighth aspect of the disclosure can be described as a carbon dioxide (CO₂) capture material infused into the support according to any one of the fourth through sixth aspects, wherein the adsorbent material is any one of a poly(ethyleneimine), diethylenetriamine, an aminopropyl organosilane, tetraethylenepentamine, ethylenediamine, N,N′-dimethylethylenediamine, a poly(allylamine), a diethylenetriamino organosilane, a polyaziridine, a methylaminopropyl organosilane, or an ethylenediamine organosilane.

In some instances, a ninth aspect of the disclosure can be described as a carbon dioxide (CO₂) capture material according to any one of the fourth through eighth aspects, wherein the CO₂ adsorptive material comprises a polymeric material.

In some instances, a tenth aspect of the disclosure can be described as a carbon dioxide (CO₂) capture material according to the ninth aspect, wherein the polymeric material is any one of cellulose, cellulose acetate, a polyimide, a polyamide, a polyetherimide, a polyamide-imide, a polymer of intrinsic microporosity, a polysulfone, a polyethersulfone, or a polyvinylidene fluoride.

In some instances, an eleventh aspect of the disclosure can be described as a carbon dioxide (CO₂) capture module comprising a CO₂ capture material according to any one of the first through tenth aspects.

In some instances, a twelfth aspect of the disclosure can be described as a carbon dioxide (CO₂) capture module according to the eleventh aspect, wherein the module is a direct air capture (DAC) module.

In some instances, a thirteenth aspect of the disclosure can be described as a carbon dioxide (CO₂) capture module according to the eleventh aspect, wherein the module is a wind energy direct air capture (WEDAC) module.

In some instances, a fourteenth aspect of the disclosure can be described as a carbon dioxide (CO₂) capture module according to the thirteenth aspect, wherein the module is configured to transition between an open configuration and a closed configuration, wherein in the open configuration, the CO₂ capture material is open to an external environment for adsorption of CO₂ from air in the external environment onto the CO₂ capture material, and in the closed configuration, the CO₂ capture material is isolated from the external environment for controlled desorption of the CO₂ from the CO₂ capture material.

In some instances, a fifteenth aspect of the disclosure can be described as a carbon dioxide (CO₂) capture module according to the fourteenth aspect, wherein the controlled desorption is vacuum-assisted and electrothermal.

In some instances, a sixteenth aspect of the disclosure can be described as a method removing CO₂ from a mixture of gases comprising transmitting the mixture of gases across a surface of a CO₂ capture material according to any one of the first through tenth aspects, and removing CO₂ from the mixture of gases by adsorption of the CO₂ on the surface of the CO₂ capture material.

In some instances, a seventeenth aspect of the disclosure can be described as a method removing CO₂ from a mixture of gases comprising transmitting the mixture of gases through a CO₂ capture module according to any one of the eleventh through fifteenth aspects, and removing CO₂ from the mixture of gases by adsorption of the CO₂ on the surface of the CO₂ capture material.

### BRIEF DESCRIPTION OF THE DRAWINGS

FIG. 1A shows cross-sectional and FIG. 1B shows surface SEM images of sorbent-coated carbon fibers from the roll-to-roll coating with a winding speed of 500 mm/min.

FIG. 2A shows electric current (I-V curve) and FIG. 2B shows Joule heating temperature of the carbon fibers (10 cm—blue, 20 cm—green) and the sorbent-coated carbon fibers (22.5 cm—red) as a function of the electric potential applied. The fiber length and numbers are displayed in the top-left of the graphs with corresponding symbols. The black dashed guidelines in the left graph indicate the electric resistance line based on Ohm's law. The yellow box in FIG. 2B indicates the desorption temperature range.

FIG. 3A shows a temperature-time profile of the Joule heating cycle. Power on/off the DC power supply is indicated in the graph. 20 cm of carbon fiber (black squares) and 22.5 cm of sorbent-coated carbon fiber (red circles) were tested under 12 V. 22.5 cm of sorbent-coated carbon fiber bundle with six fibers (red stars) was tested under 7 V. FIG. 3B shows thermal images of the carbon fiber (top), sorbent-coated carbon fiber (middle), and the bundle (bottom) during the Joule heating cycle (i) before power on, (ii) at peak temperature, and (iii) after power off (left to right). The temperatures at the top-left of each image were from the fiber center. The temperature bar at the right side of each image ranged from the lowest to highest temperature in the images.

FIG. 4 shows CO₂ uptake behavior as a function of time for the sorbent layer at 30° C. under 400 ppm CO₂. The legends at the bottom-right of the graphs indicate PEI impregnation conditions. Feed gas conditions are shown at the top of each graph.

FIG. 5A shows cyclic adsorption/desorption of the sorbent layer prepared from 10 wt. % PEI/MeOH impregnation solution, as measured by TGA connected with a downstream CO₂/H₂O gas analyzer. Data plotted on the upper and lower graphs were obtained from the same experiment and share the x-axis of time on the lower graph. The dashed arrows indicate the amount of CO₂ adsorption for each cycle.

FIG. 5B is a bar graph of CO₂ adsorption for each cycle. The horizontal grey dashed line indicates the average CO₂ uptake of the 2^{nd}-10^{th} cycles.

FIG. 6 is a schematic illustration of an exemplary breakthrough experimental setup for electrically-driven thermal swing adsorption (ETSA) and vacuum and electric swing adsorption (VETSA). Gas flows along a path shown by blue arrows. Abbreviations: MFC—mass flow controller; THM—temperature-hygrometer; TI—temperature indicator.

FIG. 7A shows breakthrough and FIG. 7B shows CO₂ desorption curves of a sorbent-coated carbon fiber module for consecutive TSA and ESA cycles. The desorption was conducted after the corresponding adsorption steps.

FIG. 8A shows CO₂ desorption of the sorbent-coated carbon fiber modules in electrothermal (red) and vacuum-electrothermal (green) desorption. FIG. 8B shows thermal images of the module during the vacuum-electrothermal desorption.

FIGS. 9A-9F show breakthrough curves (FIGS. 9A, 9C and 9E) and electrothermal desorption (FIGS. 9B, 9D and 9F) of the DAC module under dry conditions (FIGS. 9A and 9B), humid conditions (FIGS. 9C and 9D), and pre-hydrated conditions (FIGS. 9E and 9F).

FIG. 10 shows an exemplary roll-to-roll coating system for the fabrication of sorbent-coated carbon fibers.

FIGS. 11A and 11B show sorbent-coated carbon fibers made by hand dip-coating (FIG. 11A) and roll-to-roll coating (FIG. 11B). The numbers above each fiber bundle in FIG. 11B indicate the winding speed of the roll-to-roll coating.

FIG. 12A, FIG. 12B and FIG. 12C show thermal images of the carbon fibers under the electric potential written in the bottom-left of each image. The temperatures at the top-left of each image were from the fiber center. The temperature bar at the right side of each image ranged from the lowest to highest temperature in the images.

FIG. 13 shows thermal images of the sorbent-coated carbon fibers under the electric potential written in the bottom-left of each image. The temperatures at the top-left of each image were from the fiber center. The temperature bar at the right side of each image ranged from the lowest to highest temperature in the images.

FIG. 14 shows TGA profiles of sorbent coating layers with various amounts of PEI impregnation.

FIG. 15 shows nitrogen physisorption (at Temperature=77 K) profiles of sorbent coated carbon fibers with various amounts of PEI impregnation.

FIG. 16 shows CO₂ uptakes as a function of time for the sorbent layer at 30° C. under pure CO₂. The legends at the bottom-right of the graphs indicate PEI impregnation conditions. Feed gas conditions are shown at the top of each graph.

FIG. 17 is a schematic illustration of an exemplary breakthrough experimental setup for temperature swing adsorption (TSA). Gas flows along with blue arrows. Abbreviations: MFC—mass flow controller; THM—temperature-hygrometer; TI—temperature indicator.

FIGS. 18A and 18B show CO₂ concentration curves with (FIG. 18A) desorption working capacity and (FIG. 18B) temperature detected during the thermal (blue) and electrothermal desorption (red).

FIG. 19A a dry temperature-programmed desorption (TPD) profile of sorbent-coated carbon fibers prepared from 10 wt % PEI solution infusion. The numbers in brackets indicate the corresponding steps—(1) water pre-hydration, (2) CO₂ adsorption, (3) purge, (4) TPD, and (5) isothermal.

FIG. 19B is a wet temperature-programmed desorption (TPD) profile of sorbent-coated carbon fibers prepared from 10 wt % PEI solution infusion. The numbers in brackets indicate the corresponding steps: (1) water pre-hydration, (2) CO₂ adsorption, (3) purge, (4) TPD, and (5) isothermal.

FIG. 19C is a graph showing CO₂ and H₂O concentration profiles in the purge, TPD, and isotherm steps of FIGS. 19A and 19B (black and blue lines were from dry and humid TPD measurements, respectively).

FIG. 20 shows breakthrough curves of the surface-coated carbon fiber modules for four adsorption/desorption cycles.

FIGS. 21A and 21B show concentration profile of CO₂ (red) and N₂ (gray) during (FIG. 21A) externally driven thermal desorption and (FIG. 21B) electrothermal desorption under 100 standard cubic centimeters per minute (sccm) Ar purging. The enclosed areas with concentration curve and dashed base line were calculated for adsorption concentration ratio between CO₂ and N₂.

FIG. 22 shows module surface temperature (left graph) and thermal images of the DAC modules (right images) with natural cooling time.

FIGS. 23A and 23B show breakthrough curves (FIG. 23A) and electrothermal CO₂ desorption curves (FIG. 23B) of the surface-coated carbon fiber modules with various feed flowrate.

FIG. 24 shows normalized concentration profile of CO₂ and H₂O during pre-hydration step.

FIG. 25 is an image of a wind energy direct air capture (WEDAC) module in an open configuration for the adsorption of CO₂.

FIG. 26 is an image of the WEDAC module of FIG. 25 in a closed configuration for the vacuum-assisted electrothermal desorption of CO₂.

FIG. 27 is a thermal image of the WEDAC module of FIG. 25 in the open configuration at 25.7° C. and 5V for 3 minutes.

FIG. 28 is a thermal image of the WEDAC module of FIG. 25 in the open configuration at 73.6° C. and 5V for 3 minutes.

FIG. 29 is a schematic illustration of the use of a WEDAC module in the open configuration for the adsorption of CO₂ , followed by transitioning the WEDAC module to the closed configuration for the vacuum-assisted electrothermal desorption of CO₂.

FIG. 30 is an image of an exemplary bundle of sorbent-coated carbon fibers for use in a DAC module.

FIG. 31 is an image of an exemplary DAC module for use with a bundle of sorbent-coated carbon fibers according to the disclosure.

### DETAILED DESCRIPTION OF THE INVENTION

In this invention, carbon fibers were coated with mesoporous silica (SYLOID® C-803) and cellulose acetate (CA) using a roll-to-roll coating system and then impregnated with poly(ethyleneimine) (PEI) within the coating layer. A fibrous configuration for the DAC modules was chosen for scalable CO₂ sorbent fabrication. The electrothermal properties and CO₂ adsorption capacity of the sorbent-coated carbon fibers were investigated. Fabricated modules with the sorbent-coated carbon fibers were then prepared for use in DAC-relevant experiments. The CO₂ adsorption performance of the modules was measured in the ETSA system under various DAC-relevant conditions. The effects of vacuum, purge flow rate, and humidity on the ETSA performance of the DAC modules were demonstrated. The ability to achieve reasonable CO₂ capacities in these systems as well as enable rapid thermal cycles via the usage of Joule heating has been demonstrated.

### Sorbent-Coated Carbon Fibers From Dip-Coating

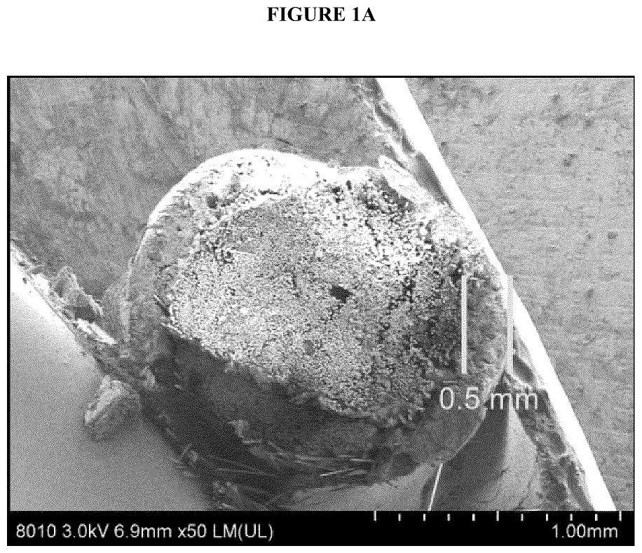

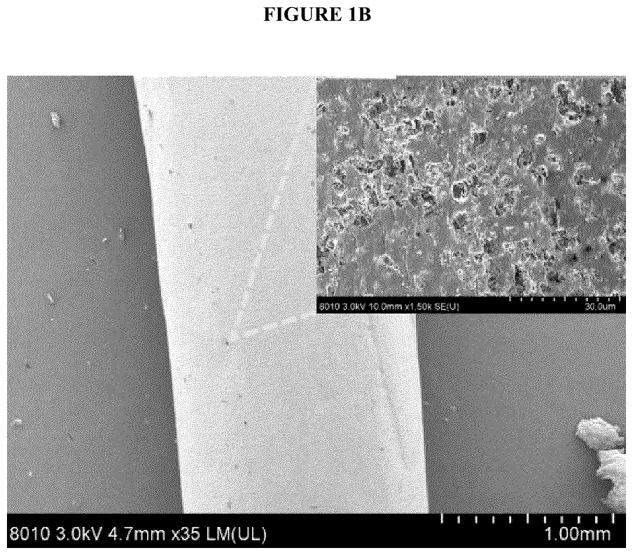

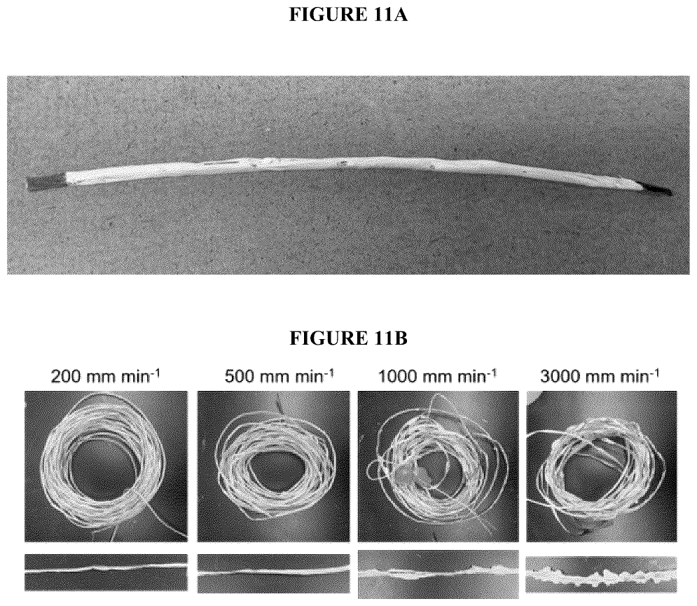

Carbon fibers were initially coated by hand using a dip-coating technique (see Examples). The hand coated carbon fibers were observed to have a uniform white solid surface and exhibited good sorbent dope adhesion to the carbon fiber tow (FIG. 11A). Phase inversion of the coating dope in the water was observed to immediately initiate throughout the fiber, indicating potential for effective processing in a continuous coating system. In the roll-to-roll coating process, the coating speed was controlled by the winding rate of the take-up drum. The sorbent-coated carbon fibers were collected at varying winding speed in the range of 200-3000 mm/min, and all of the materials exhibited completely covered surfaces (FIG. 11B). The carbon fibers coated at 500 mm/min were found to be 50 wt. % sorbent layer relative to the total coated fiber mass. The amount of the coating layer increased with winding speed, where the sorbent-coated carbon fibers from 3000 mm/min showed 71 wt. % of the coating layer. However, a non-uniform coating was observed at speeds in excess of 1000 mm/min, and these coatings were also found to have poor adhesion after drying. Without wishing to be bound by theory, the inventors theorize that liquid phase instabilities from the non-Newtonian coating dopes are essentially frozen due to rapid phase inversion at these higher rates, and fibers created at higher coating speeds were therefore not pursued further. Therefore, the 500 mm/min winding was used for the roll-to-roll dip-coating to achieve uniform coatings and high mass fractions of sorbent layers on the carbon fibers. As shown in the cross-sectional SEM image, the fiber had a dual-layer structure where the carbon fiber at the center was uniformly coated with the sorbent layer (FIG. 1A). Moreover, the coating layer exhibited a porous morphology with well-distributed C803 mesoporous silica into the continuous cellulose acetate (CA) phase. The surface of the sorbent-coated carbon fiber was homogeneous; however, macropores were formed at the surface from the phase inversion in the coagulation bath (FIG. 1B). These pores provide gas transport routes to the silica particles throughout the coating layer.

### Electrical Properties and Joule Heating of the Sorbent-Coated Carbon Fibers

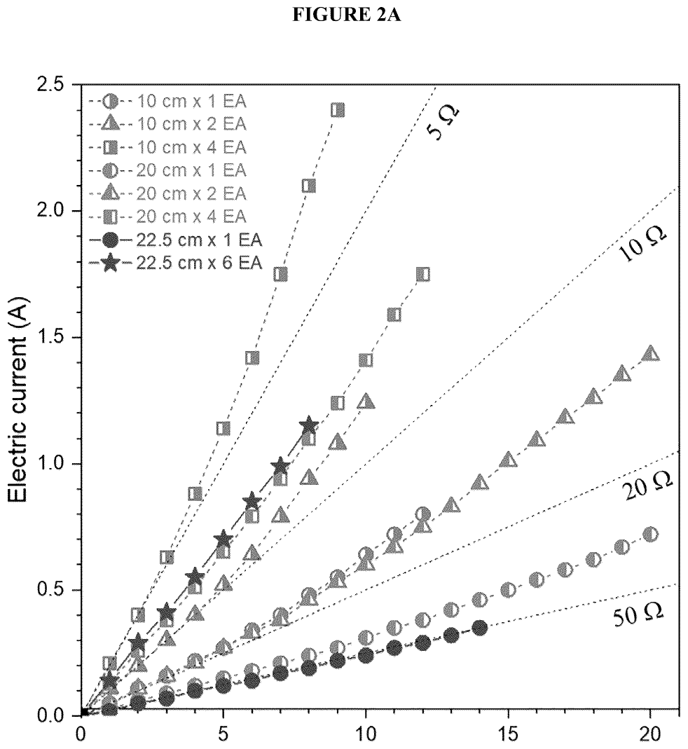

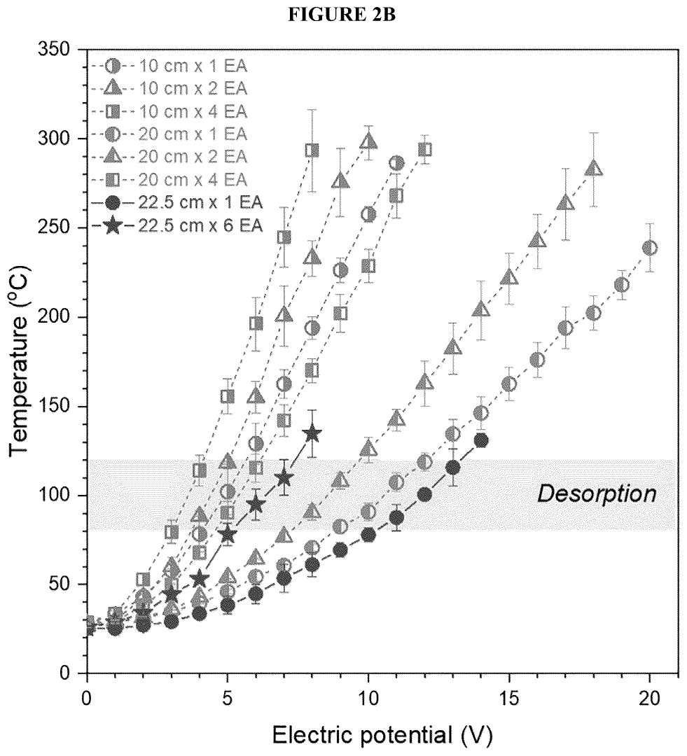

The effect of the length and the number of the carbon fibers on their electrical properties and Joule heating behavior was studied. All the carbon fibers, regardless of length and number of fibers in the module, were observed to follow Ohm's law (V=I·R, where V is voltage, I is current, and R is resistance) at the low voltage, i.e., a linear relationship between electric current and potential was exhibited (FIG. 2A). However, their I-V curves exhibited an upward deviation with increasing voltage, indicating that the increased temperature from Joule heating reduced the electrical resistance of the carbon fiber or sorbent-coated carbon fiber. In addition, since the electrical resistance was proportional to the length of the carbon fibers but inversely proportional to their area (R∝^{l}/_{A}), (R the shorter the length and the greater the number of fibers in a bundle, the lower the electrical resistance. For example, 10 cm×4 carbon fibers (right-half blue squares in FIG. 2) exhibited ˜4 times higher electric current than 20 cm×2 (left-half green triangles in FIG. 2). The configuration of the fibers can impact the electrical properties even with the same amount of carbon fiber.

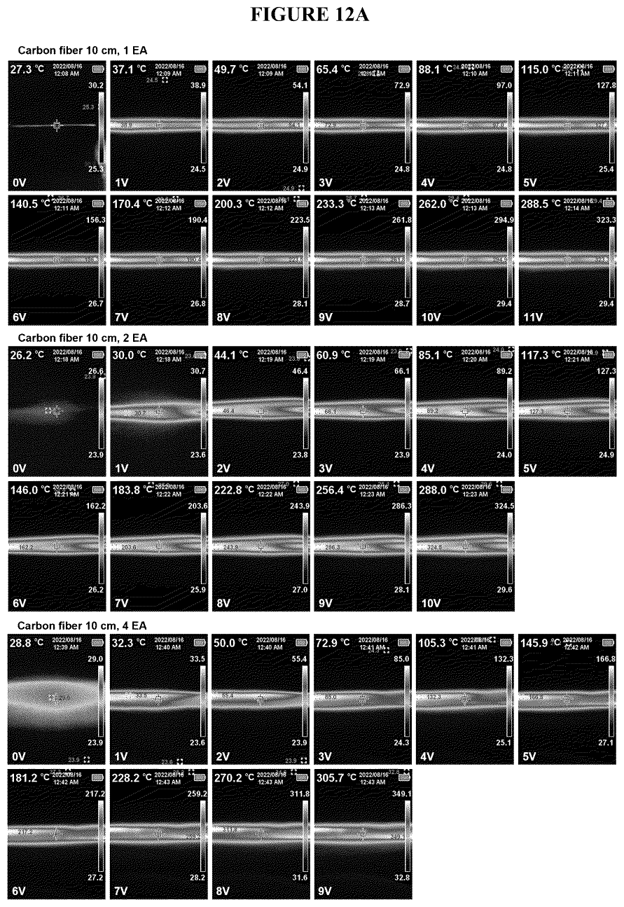

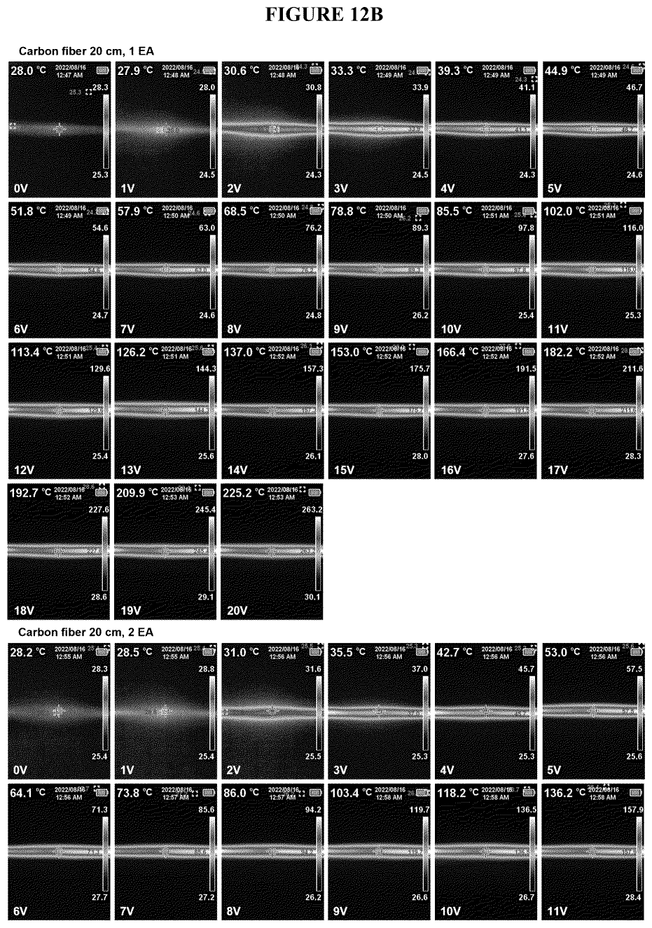

The temperature of the carbon fibers was observed to increase non-linearly with increasing electric potential (FIG. 2B and FIGS. 12A-12C). As with the trend of electric current relative to voltage, the bundle with the greater number of shorter carbon fibers reached higher temperatures due to the larger electrical energy applied. However, the fiber length was more important for the temperature than the number of fibers. For instance, although the 10 cm×1 carbon fiber (right-half blue circles in FIG. 2) and the 20 cm×2 carbon fibers (left-half green triangles in FIG. 2) configuration exhibited the same electric current at low potential, the former showed higher Joule heating temperatures. The 10 cm×1 carbon fiber reached 262° C. at 10 V, which was 144° C. higher than the 20 cm×2 carbon fiber bundle at the same voltage. Therefore, shorter fibers can reach higher temperatures for the same mass of carbon fiber.

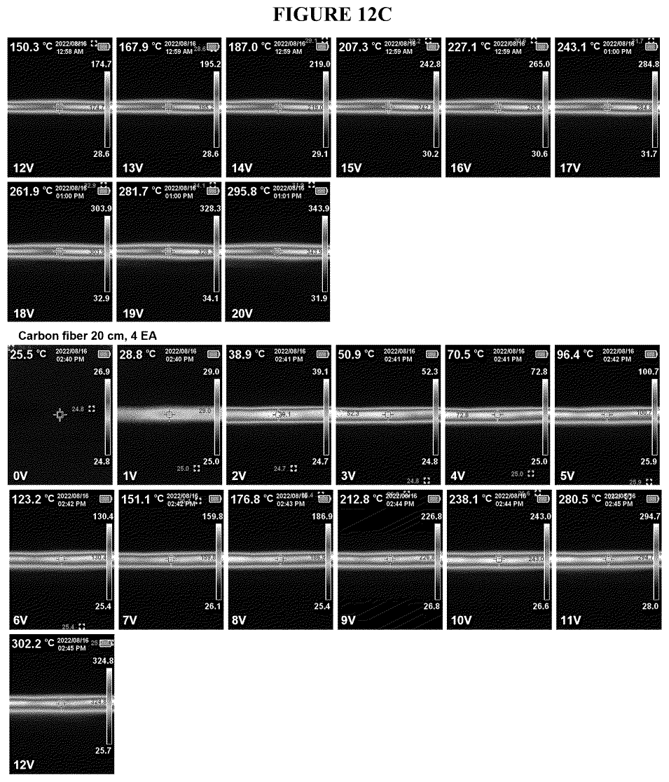

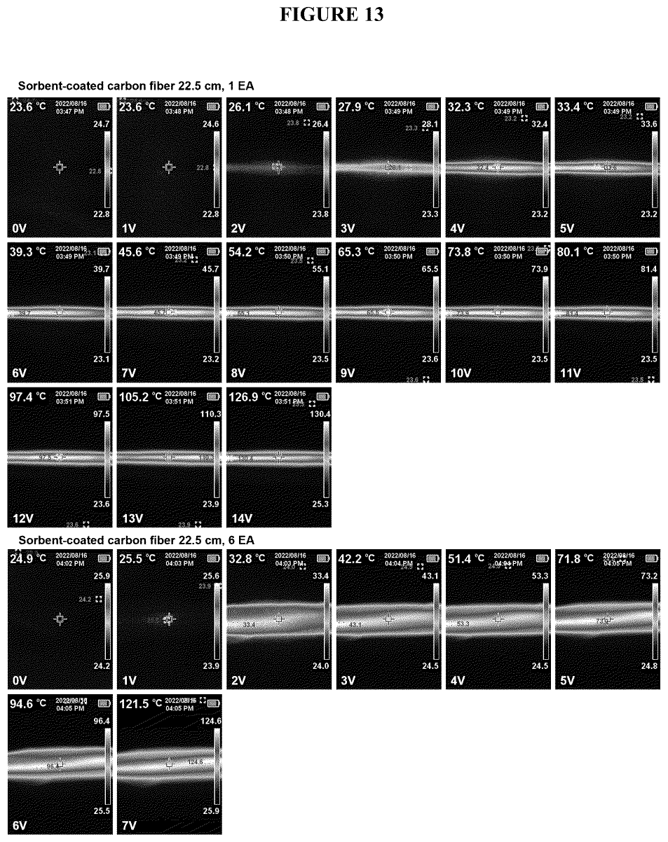

Joule heating has also been explored for the sorbent-coated carbon fibers (FIG. 13). The 22.5 cm sorbent-coated carbon fiber and its bundle containing six fibers were prepared (red circles and stars in FIG. 2, respectively). The electrical properties of the fibers were found to be largely unchanged after the coating process, likely as a result of the non-conductive nature of the cellulose acetate/mesoporous silica (CA/C803) coating layer. Consequently, the bundle exhibited six times higher electric current than the single sorbent-coated carbon fiber. Likewise, the carbon fibers with coating layers also exhibited Joule heating behavior, following the same temperature trends as the uncoated carbon fibers. The 22.5 cm sorbent-coated carbon fiber strand reached typical CO₂ desorption temperatures (i.e., 90-110° C.) at 11-14 V. On the other hand, the fiber bundle exhibited a much steeper temperature increase, entering the CO₂ regeneration range at 5-8 V. Hence, the sorbent-coated carbon fibers were feasible as Joule heating media for electric swing adsorption.

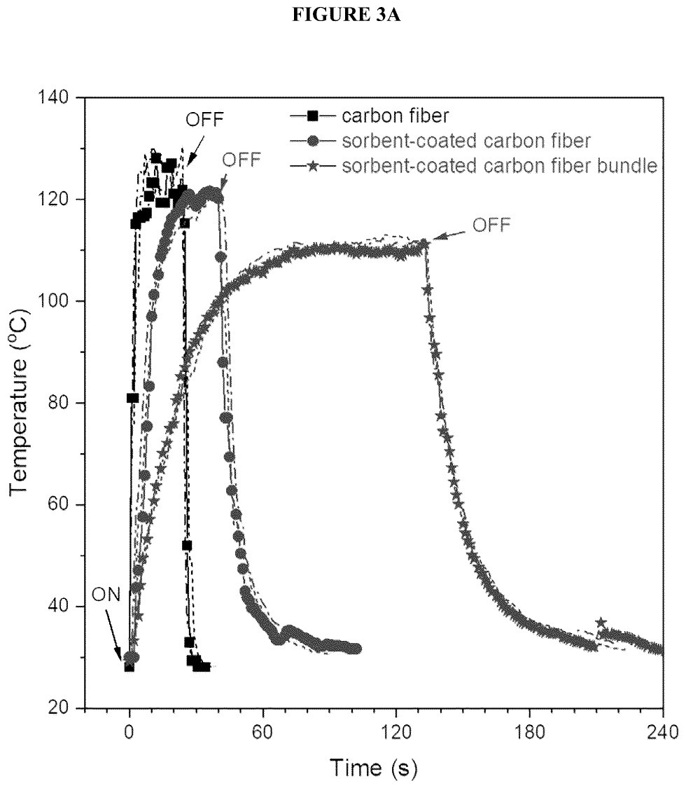

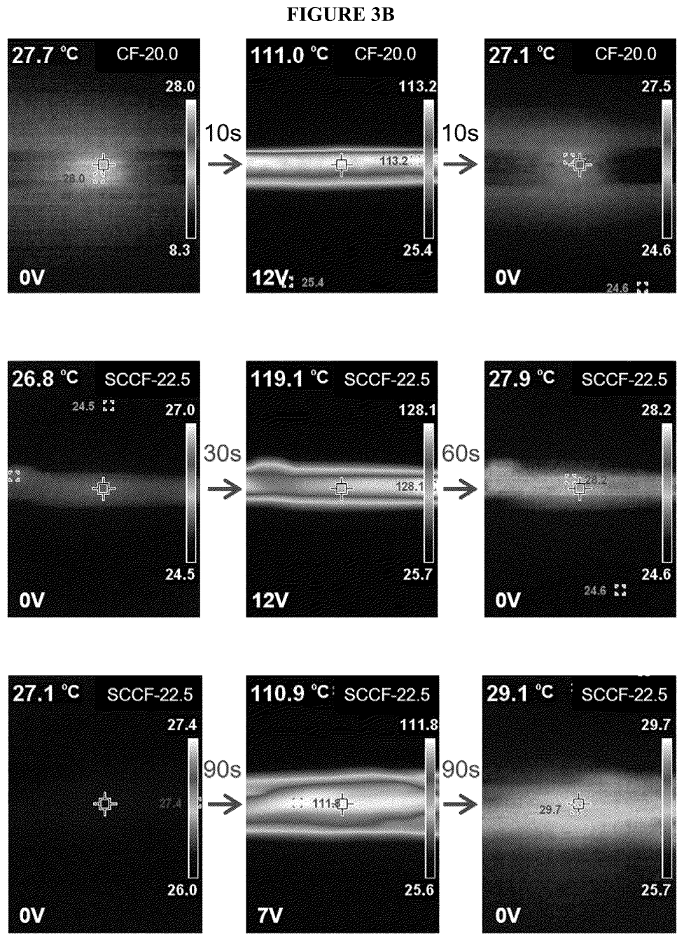

Furthermore, the temperature change of the fibers by Joule heating was monitored over time since rapid temperature control is an essential part of the ETSA process (FIG. 3A). Given an electric potential of 12 V, which was found to be appropriate for generating a temperature inducing CO₂ desorption (FIG. 2), a 20 cm carbon fiber and 22.5 cm sorbent-coated carbon fiber were observed to heat to the target temperature (90-110° C.) within ten seconds. Both fibers maintained this target temperature under constant voltage. After turning off the DC power supply, the fibers cooled to room temperature via natural convection within ten seconds. The sorbent layer was found to moderately increase the heating and cooling rates relative to the un-coated fibers, likely because of the much lower thermal conductivity of the polymer compared to the carbon fiber. It was observed that the sorbent-coated carbon fibers exhibited approximately 7-times slower heating and cooling rates relative to the neat carbon fiber; however, the full Joule heating cycle was still achieved in approximately one minute. The 22.5 cm bundle of six sorbent-coated carbon fibers also reached the CO₂ desorption temperature range (90-110° C.) in a few minutes under 7 V. As shown in the thermal images of the fibers during the Joule heating (FIG. 3B), the temperature was uniform throughout the length of the fiber, with less than 10° C. deviation from the target temperature across the fiber. Such uniform and rapid heating/cooling cycles are expected to be beneficial for DAC systems, specifically by increasing the productivity of the DAC system (i.e., kg CO₂ produced per kg sorbent per day).

### CO₂ Adsorption Properties of the Coating Layer

CO₂ adsorption behavior of the PEI-loaded CA/C803 outer layer peeled off the sorbent-coated carbon fibers. PEI impregnation was conducted for 12 hours at three different PEI concentrations: 5, 10, and 20 wt. % of PEI in methanol. This was done to identify advantaged PEI concentrations that resulted in reasonable CO₂ uptakes under 400 ppm CO₂ conditions.

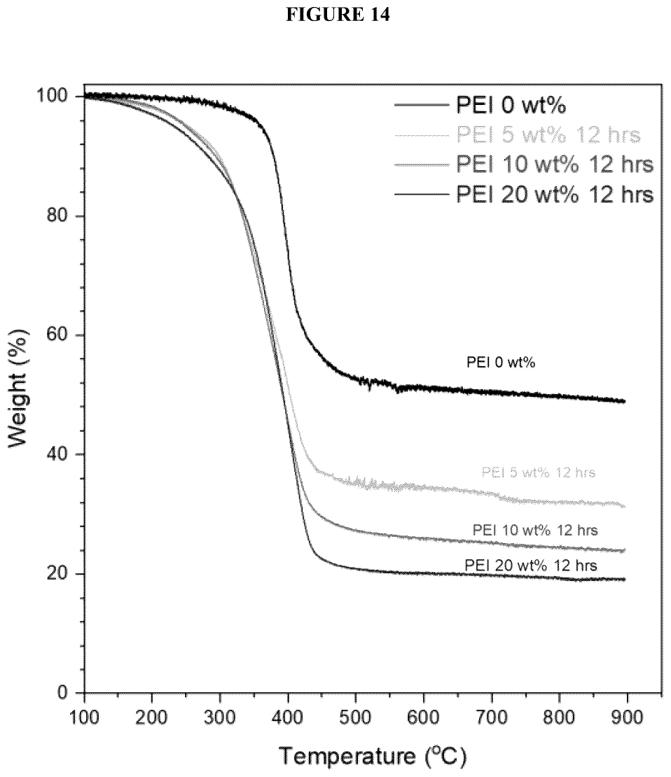

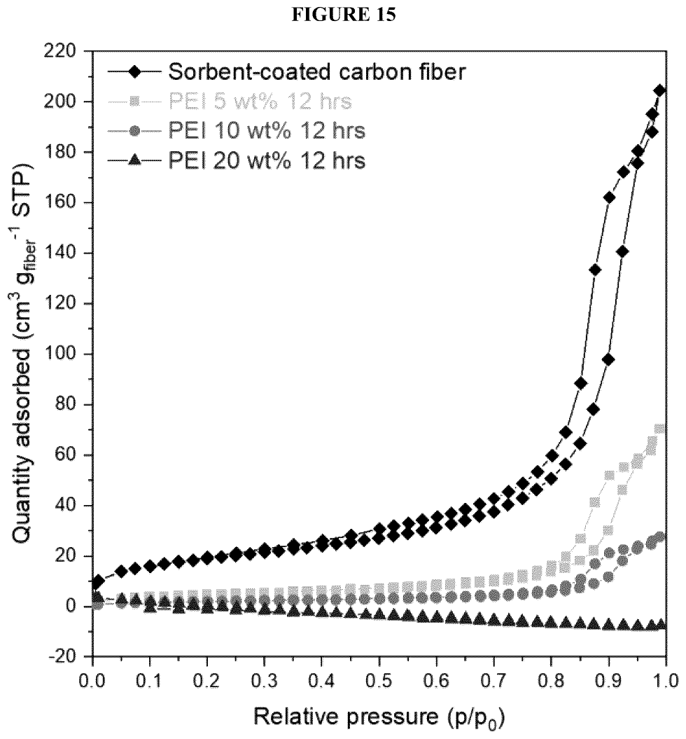

PEI loadings on the sorbent layer increased with increasing PEI concentration, in which the coating layer prepared from 5, 10, and 20 wt % solution impregnation for 12 h exhibited 0.55, 1.04, and 1.59 g_{PEI}/g_{coating}, respectively (FIG. 14). The mesoporosity of the sorbent-coated carbon fiber remained in 5 and 10 wt % PEI impregnations, showing type IV cryogenic N₂ physisorption isotherms; however, the mesoporosity was lost after impregnation with the 20 wt % solution due to pore plugging from the excessive PEI (FIG. 15). The CO₂ adsorption behavior of the PEI-loaded CA/C803 outer layer was studied by peeling it off of the sorbent-coated carbon fibers.

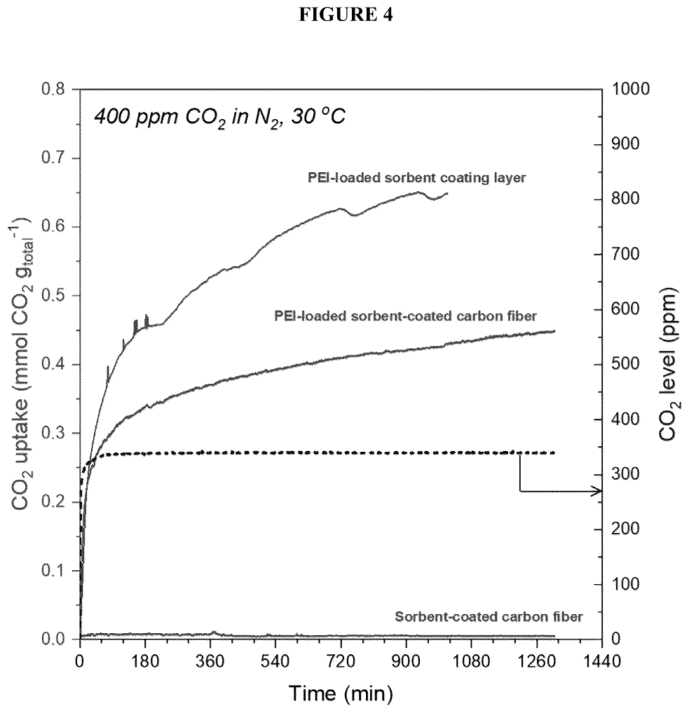

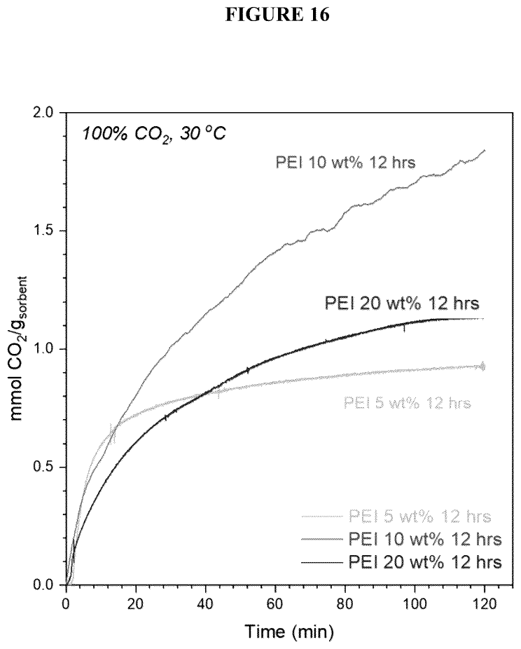

Exploratory TGA experiments using pure CO₂ at 30° C. were found to show typical non-Fickian CO₂ uptakes regardless of the PEI impregnation conditions (FIG. 16). However, the coating layer prepared from 10 wt. % PEI solution showed the highest CO₂ capacity of 1.8 mmol/g after two hours of gas exposure, among the samples tested, which is similar to the previous reports that investigated the uptake of CO₂ for post-combustion carbon capture. To further demonstrate the feasibility of the sorbent-coated carbon fibers in DAC applications, the CO₂ adsorption capacity of the sorbent layer treated with 10 wt. % PEI was evaluated under 400 ppm CO₂ (FIG. 4). In the first three hours of the adsorption experiment, the CO₂ uptake significantly increased to 0.45 mmol/g until a steady state of CO₂ concentration was achieved. Then, the sample slowly approached equilibrium, reaching a CO₂ capacity of 0.65 mmol/g after 18 hours of exposure to 400 ppm CO₂.

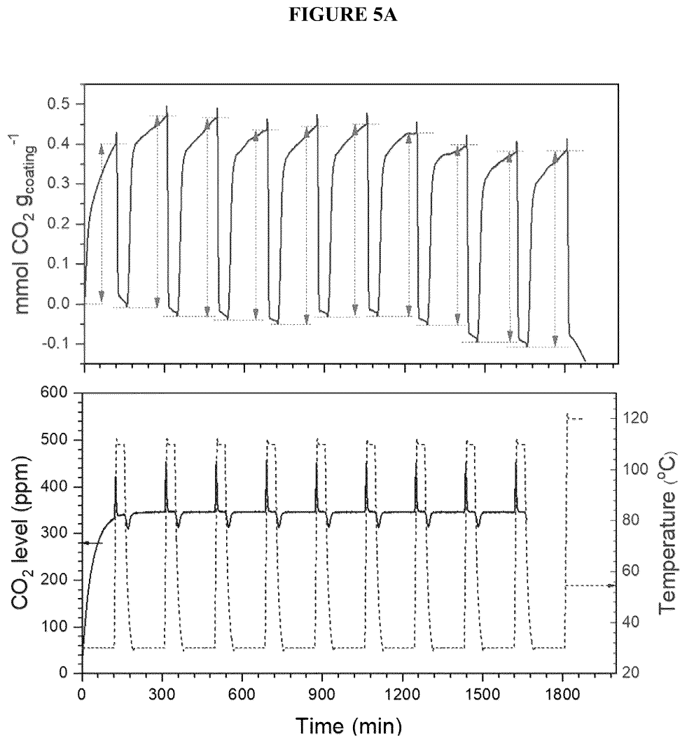

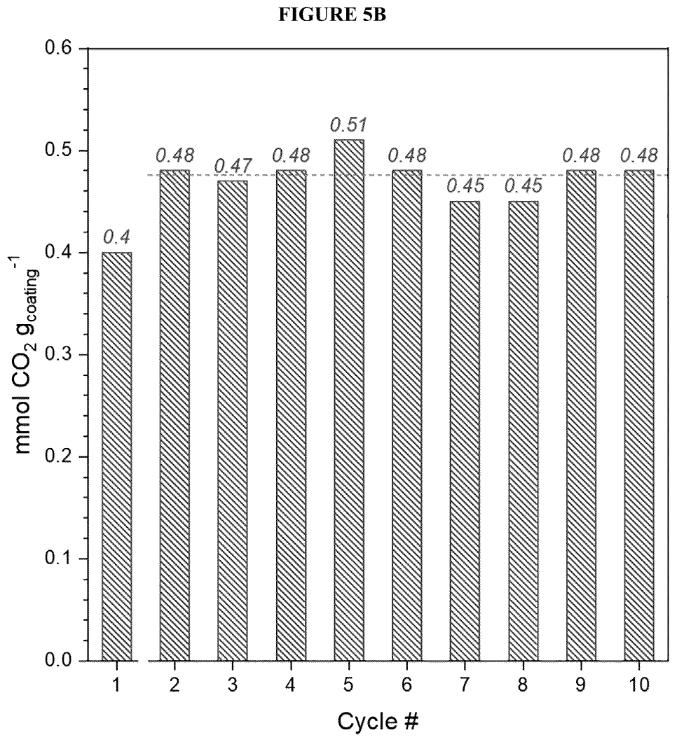

Cyclic adsorption/desorption experiments were conducted on the PEI-loaded sorbent layer under 100 sccm of 400 ppm CO₂ to better understand the cyclic stability of these materials. Ten cycles were repeated with the adsorption at 30° C. for two hours and the desorption at 110° C. for an hour under flowing 400 ppm CO₂ conditions (FIG. 5A). The sample exhibited stable CO₂ adsorption and desorption cycles with fast responses to the temperature swings within the TGA. In situ CO₂ concentration monitoring of the outlet stream also elucidated the continuous adsorptive behavior of the coating layer, showing the repeating fluctuations of CO₂ level with temperature cycles after the CO₂ level reached steady state in the first adsorption step. The sample exhibited consistent adsorption from the second to tenth cycles, with less than 10% difference in CO₂ adsorption of 0.48±0.02 mmol/g (FIG. 5B). Only the first cycle showed lower CO₂ uptake of 0.40 mmol/g, due to the transient state of the CO₂ concentration. The CO₂ concentration in the furnace does not reach the target level immediately.

### Electrically-Driven Temperature Swing Adsorption of the Sorbent-Coated Carbon Fiber Modules for DAC

### ETSA vs. TSA

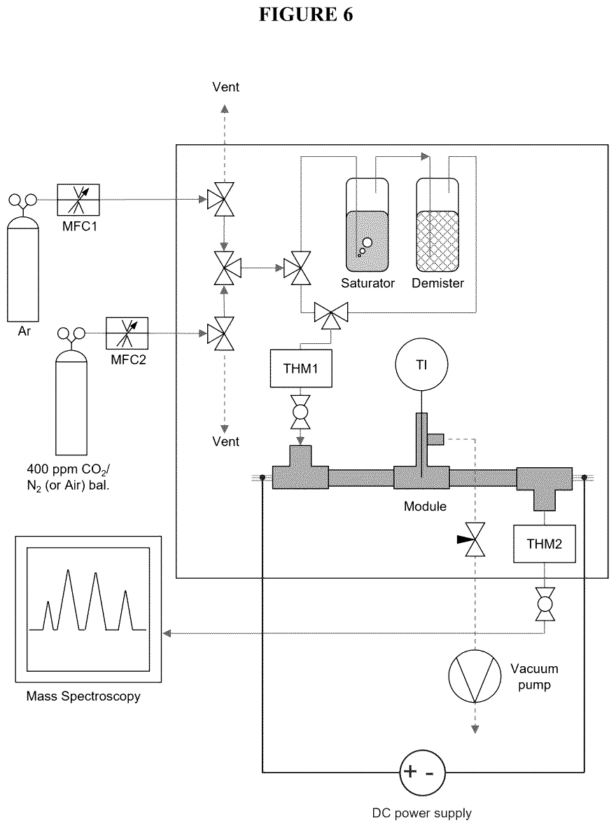

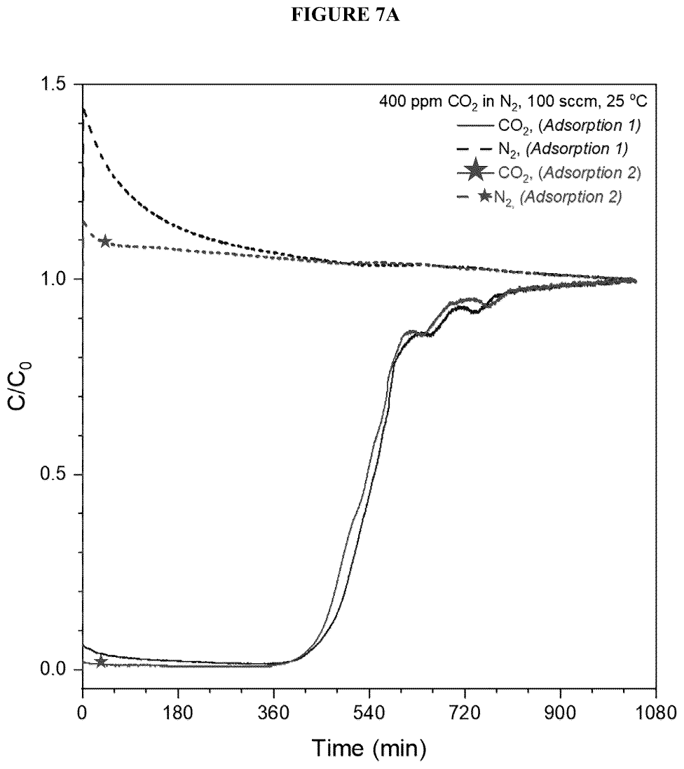

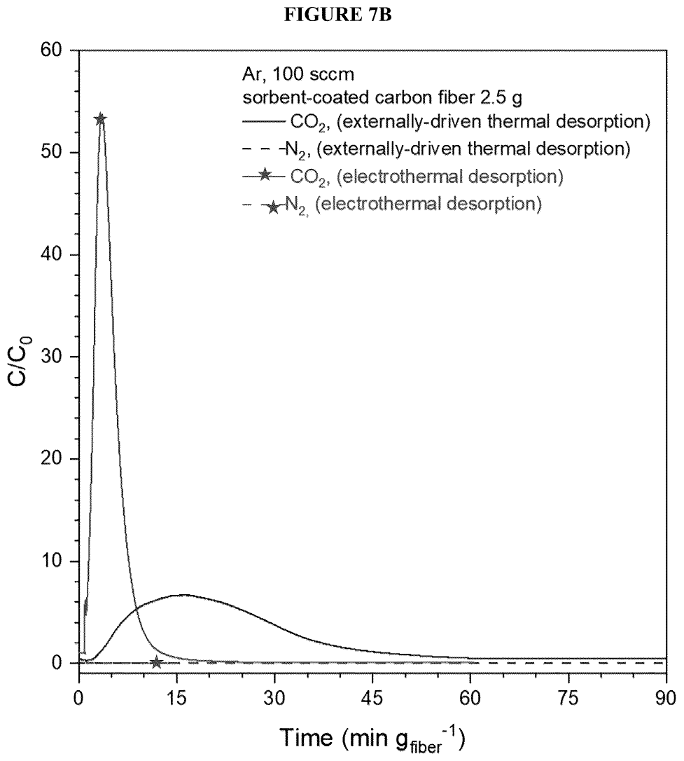

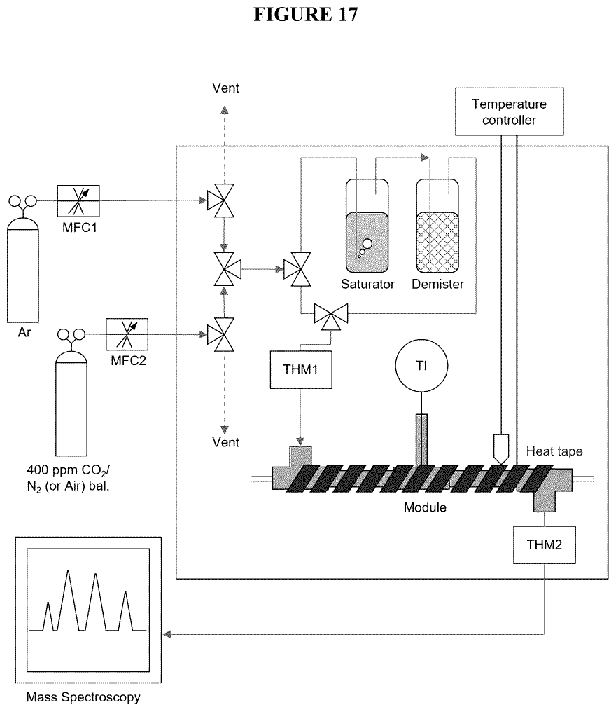

Breakthrough experiments were conducted on DAC fiber modules to compare CO₂ adsorption and desorption from TSA (FIG. 17) and ETSA (FIG. 6) conditions. The measurements were processed in the order of (i) TSA and (ii) ETSA adsorption-desorption cycles (i.e., Adsorption 1—Externally-driven thermal desorption—Adsorption 2—Electrothermal desorption) under simulated air atmospheres at 100 sccm of 400 ppm CO₂ in a N₂ feed. In the TSA cycle, the module showed a CO₂ breakthrough (C/C₀=0.05) at 170 min/g_{fiber}, with a breakthrough capacity (q_{b}) and pseudo-equilibrium capacity (qₚₑ) of 0.30 and 0.39 mmol/g_{fiber}, respectively (FIG. 7A and Table 1). The adsorbed CO₂ was regenerated during the externally-driven thermal desorption for 30 min per gram of fiber, offering a broad CO₂ concentration peak (FIG. 7B).

TABLE 1
Breakthrough Conditions and Results of the DAC Module

| | Feed | | CO₂ capacity | | |
|---|---|---|---|---|---|
| | CO₂ level | | Flow rate | q_{b} | qₚₑ |
| Adsorption | (ppm) | Balance gas | (sccm) | (mmol CO₂/g_{fiber}) | |
| Inert dry | 400 | N₂ | 50 | 0.30 | 0.35 |
| | 400 | N₂ | 100 | 0.30 | 0.39 |
| | 400 | N₂ | 200 | 0.29 | 0.45 |
| Dry | 400 | Air | 100 | 0.28 | 0.40 |
| Wet | 400 | Air | 100 | 0.15 | 1.00 |
| Pre-hydrated | 400 | Air | 100 | 0.88 | 1.21 |

q_{b}: breakthrough capacity,
qₚₑ: pseudo-equilibrium capacity

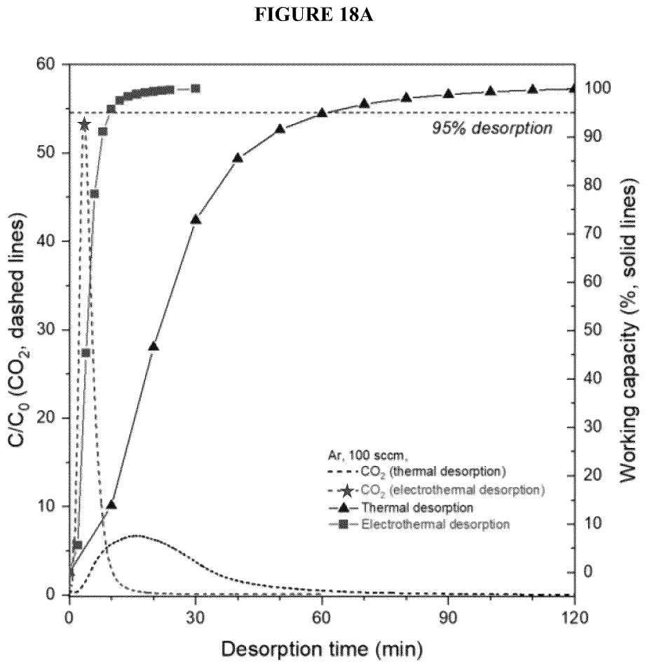

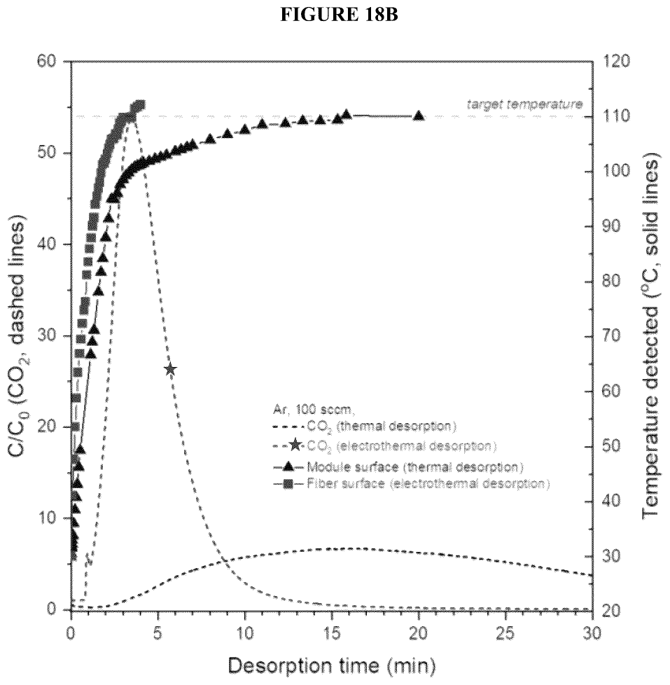

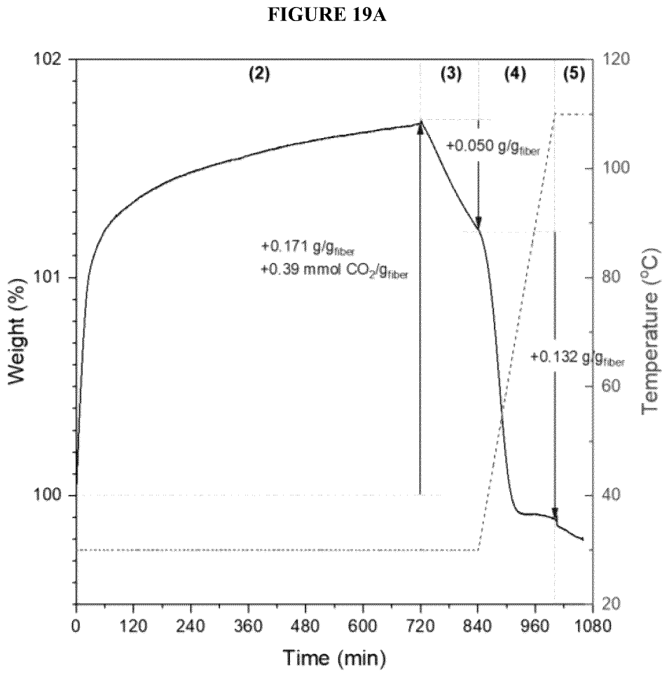

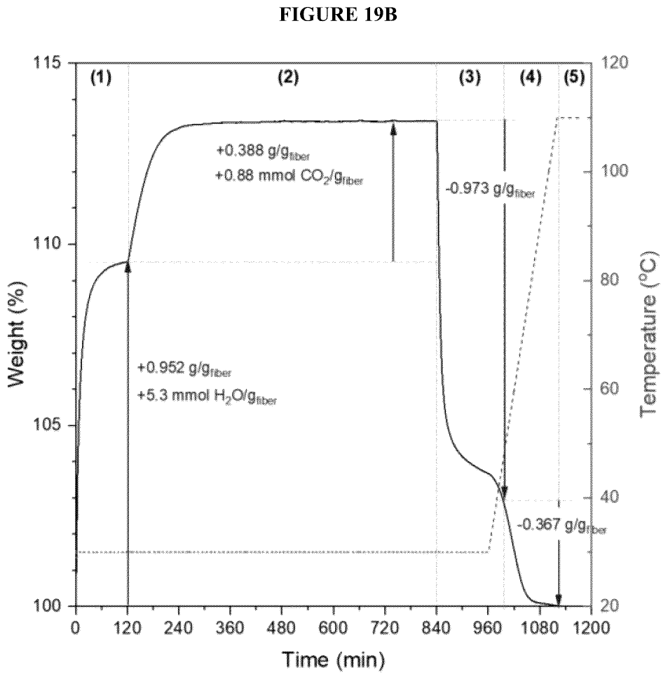

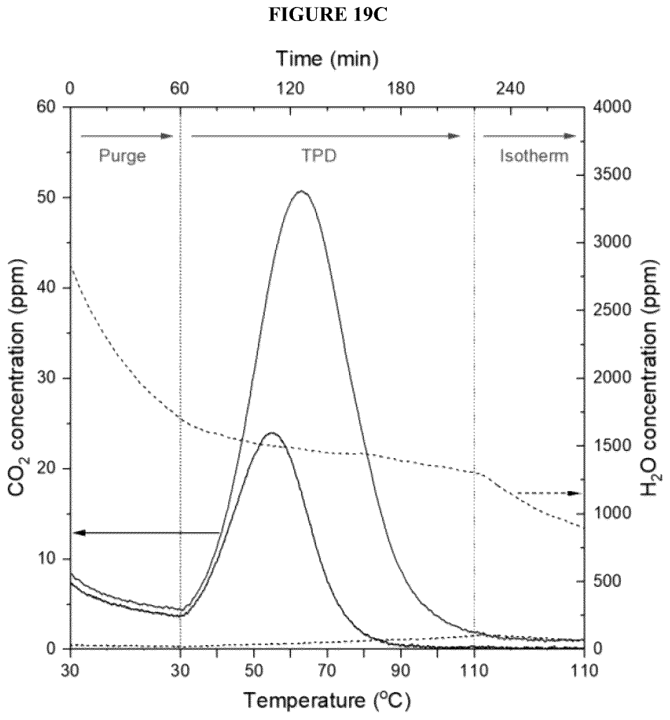

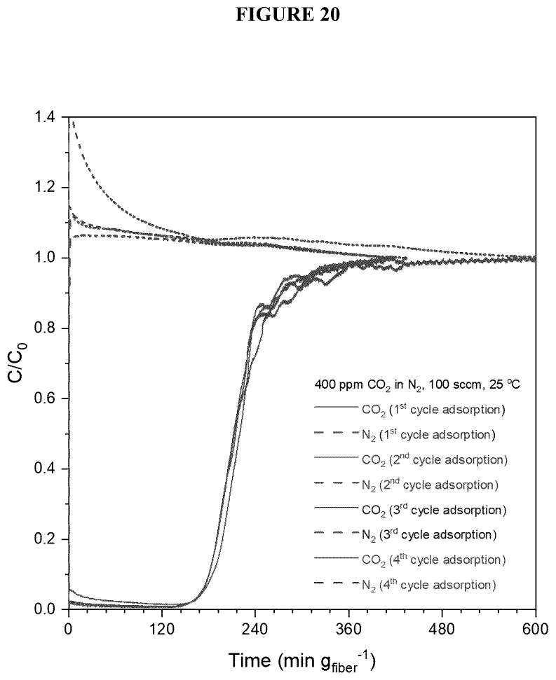

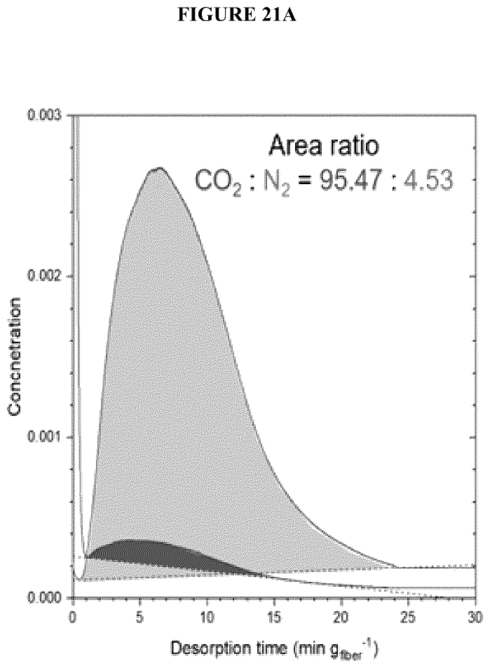

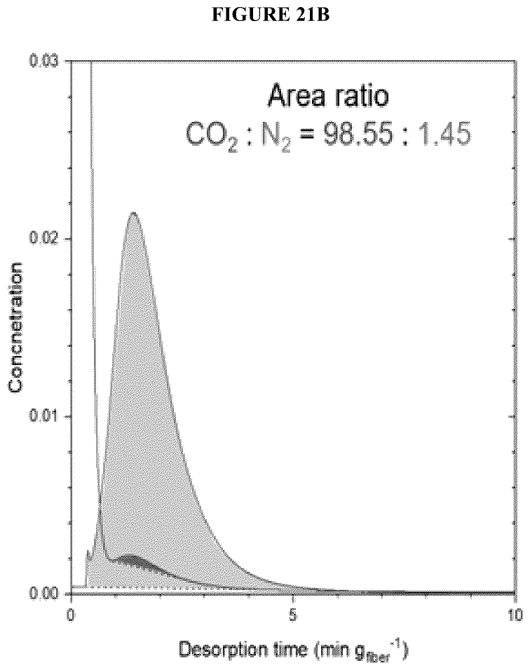

In the following ETSA cycle, the breakthrough curve of Adsorption 2 was the same as Adsorption 1, demonstrating that the adsorbed CO₂ was completely regenerated during the first thermal desorption without any thermal degradations. The electrothermal desorption was conducted by applying 7 V and 1 A to the module. It showed a narrow CO₂ concentration peak in a six-fold shorter time than the thermal desorption. We note that the area of the CO₂ desorption curve from TSA was similar to that from ETSA, indicating the electrothermal desorption also completely removed the adsorbed CO₂. It is estimated, based on these measurements, that 95% of CO₂ was regenerated from 2.5 g of the sorbent-coated carbon fibers in 10 minutes by ETSA, while TSA with external heat applied by a heating tape needed 1 hour for the same fractional desorption (FIG. 18A). The time-efficient CO₂ regeneration of ETSA was attributed to the rapid Joule heating applied directly to the fibers, whereas TSA required a longer time to reach the desorption temperature by external heating (FIG. 18B). We indicate on FIG. 18A the 95% desorption points to compare desorption time efficiency between TSA and ETSA because practical processes will never likely achieve full desorption of CO₂. The sorbent-coated carbon fibers exhibit complete desorption of the CO₂ during the temperature ramp from 30° C. to 110° C., resulting in the fiber weight returning to the initial value after adsorption-desorption cycles (FIGS. 19A and 19B). FIG. 19C shows CO₂ and H₂O concentration profiles in the purge, TPD, and isotherm steps (black and blue lines were from dry and humid TPD measurements, respectively). The module showed stable DAC performance for four ETSA cycles, exhibiting consistent CO₂ adsorption uptake and release (FIG. 20). The sorbent-coated carbon fiber modules showed good CO₂ adsorption selectivity, exhibiting CO₂ concentrations over 95% from regeneration flow in both externally-driven thermal desorption and electrothermal desorption (FIG. 21).

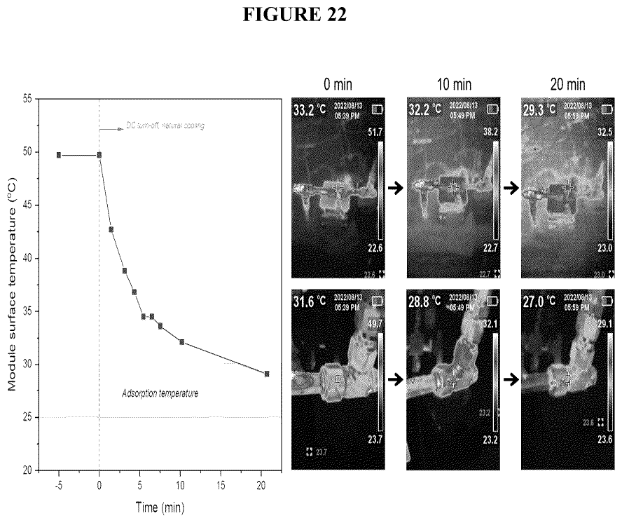

Moreover, it was observed that the outer surface of the module was heated to only 50° C. during the electrothermal desorption (FIG. 22). This lower temperature implied that Joule heating energy was not wasted on excessively sensibly heating the module. In addition to energy efficiency benefits, this also provides advantages in terms of cooling rates, as it was possible to cool the module naturally in a few minutes without an auxiliary fan.

### Electrothermal Desorption of the Module Under Various DAC Conditions

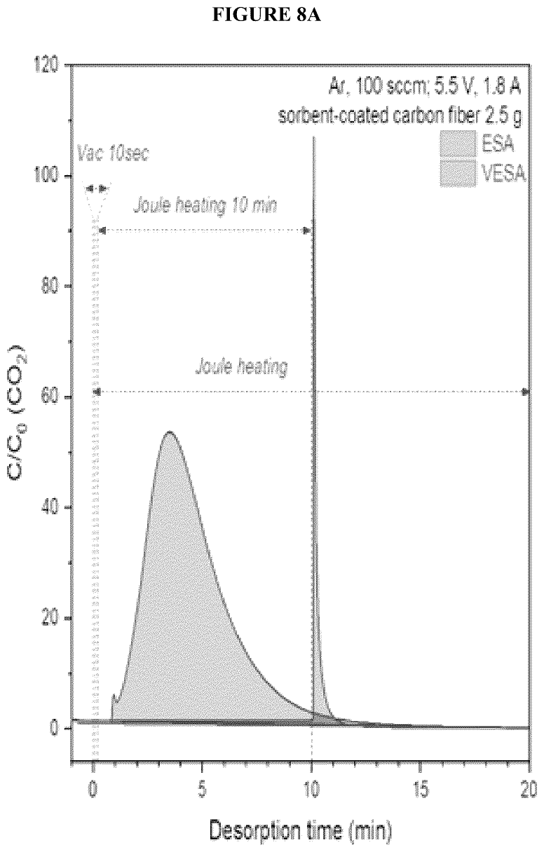

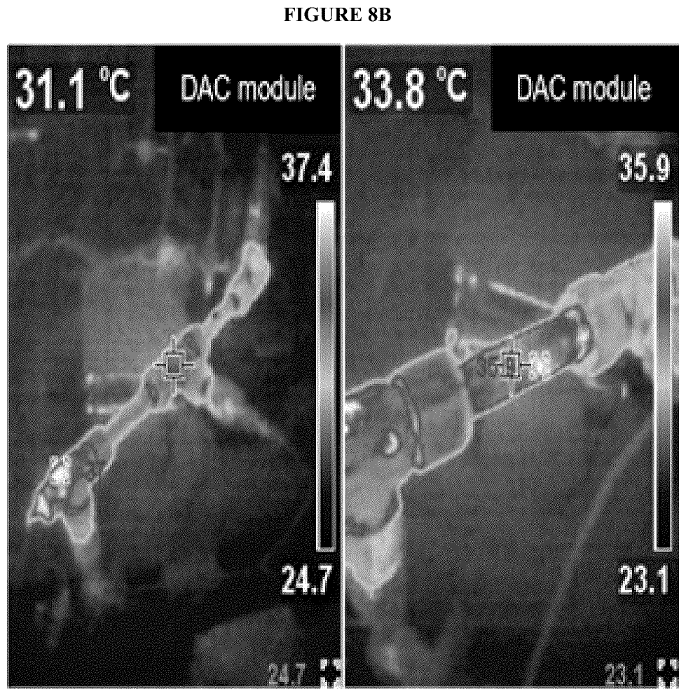

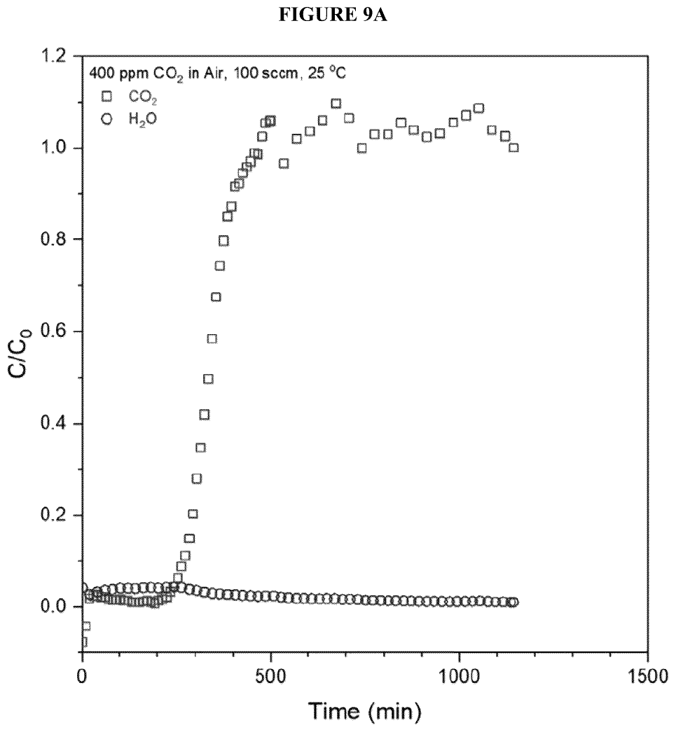

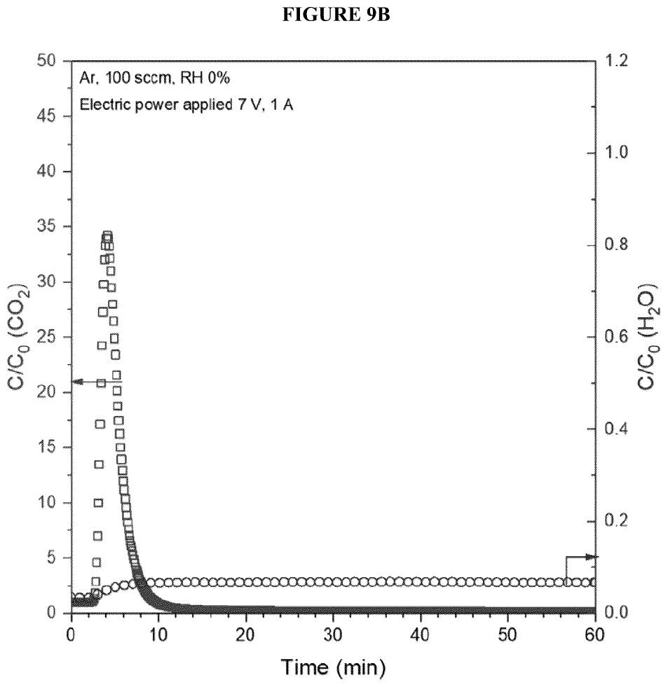

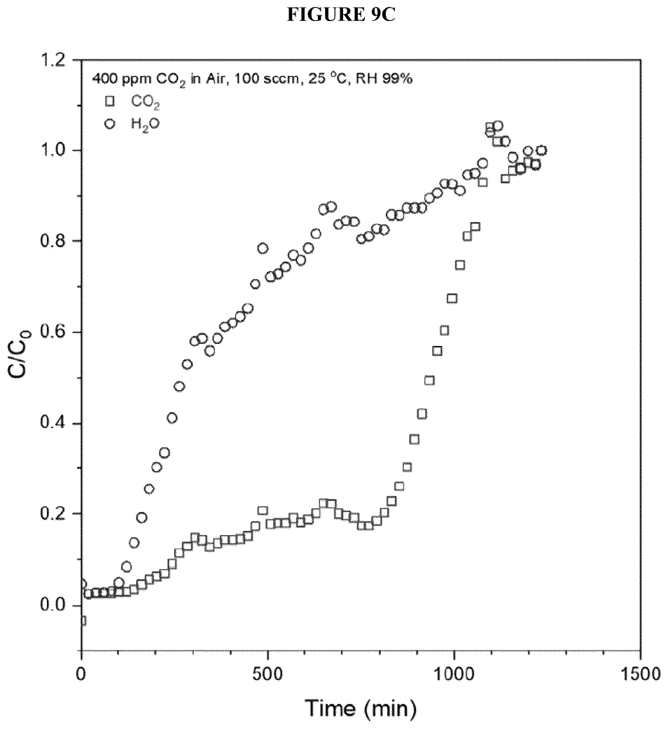

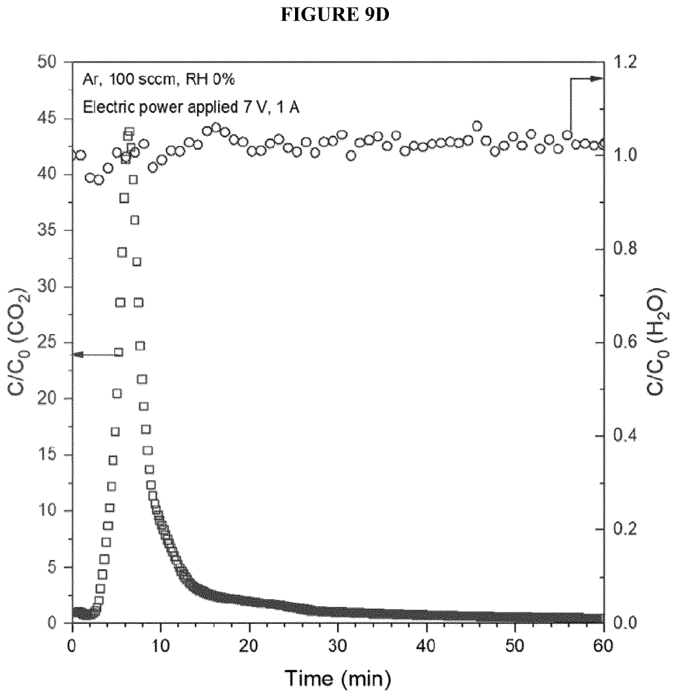

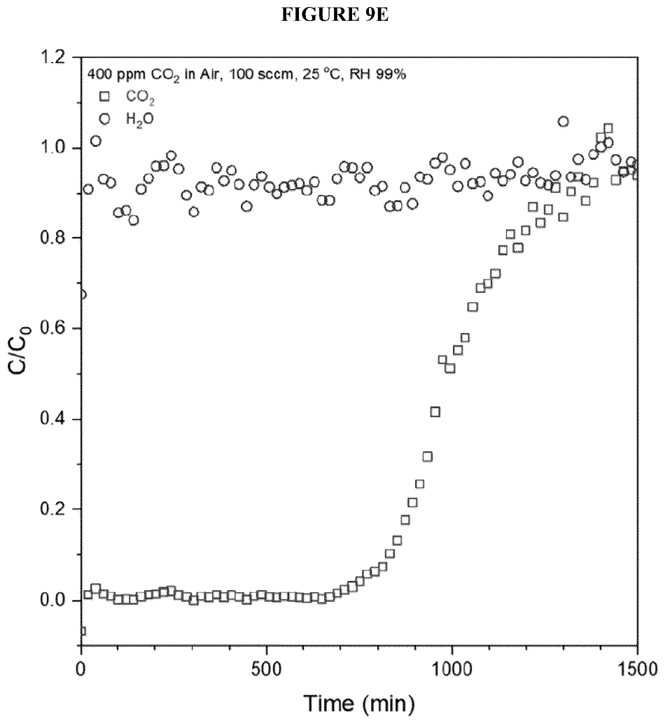

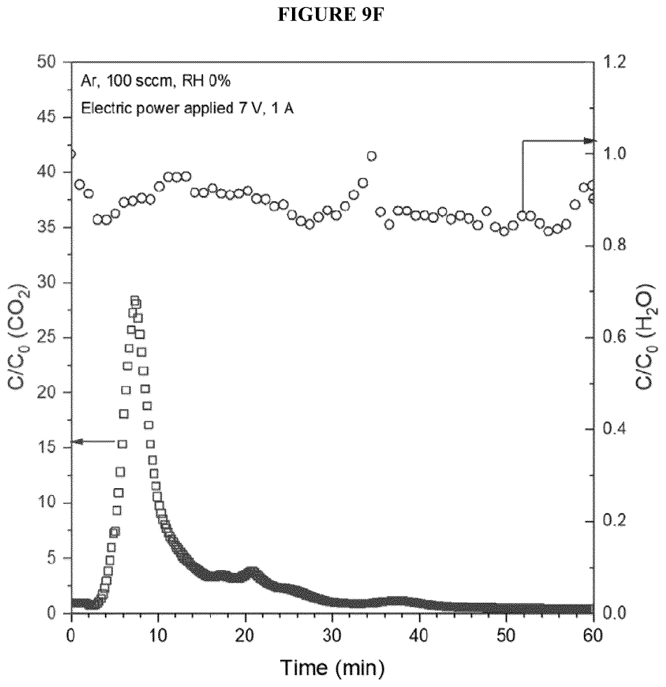

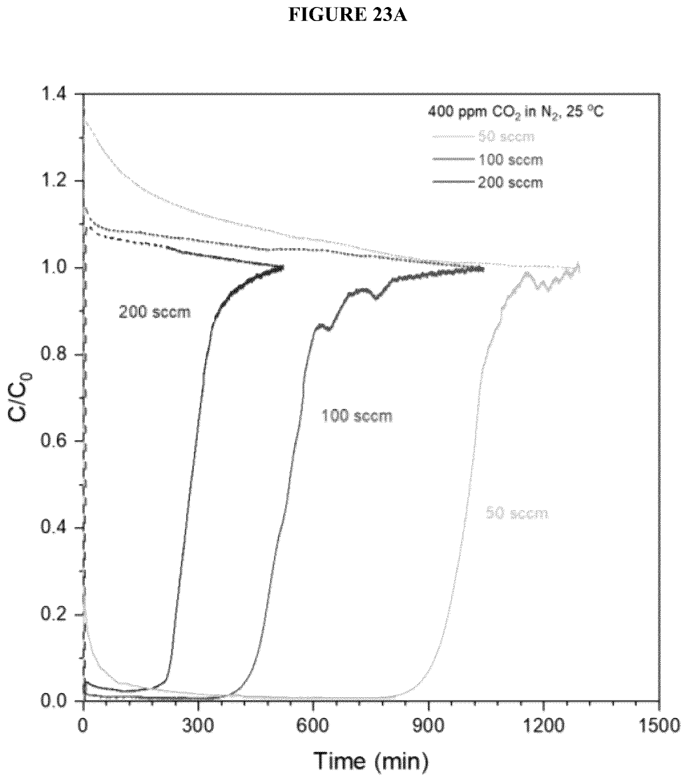

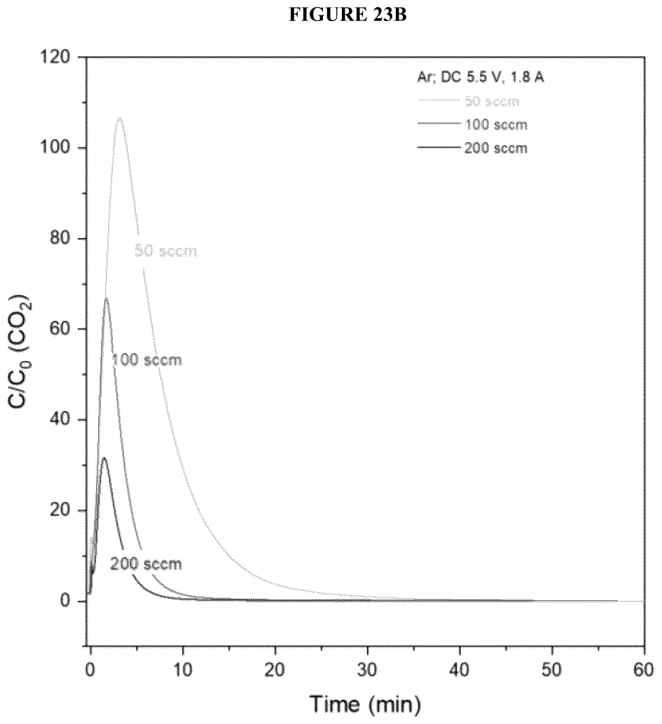

ETSA cycles were conducted on the DAC modules with different feed and purge flow rates of 50, 100, and 200 sccm (FIGS. 23A and 23B). The module responded with constant breakthrough CO₂ capacity with all feed flow rates, indicating that the dominating mass transfer resistances exist within the coating layer (Table 1). Likewise, electrothermal CO₂ desorption was stable to the purge rates, exhibiting inversely proportional desorption areas with the argon flow rate, so the larger sweep resulted in faster CO₂ desorption (FIG. 23B). Furthermore, vacuum-assisted electrothermal desorption was operated by placing the module under vacuum (<0.2 bar) for 10 seconds before the Joule heating to achieve more rapid and intensive CO₂ regeneration (FIG. 8). After Joule heating under the vacuum for 10 minutes, a 100 sccm argon sweep was applied to the module to aid in gas analysis via mass spectrometry. We observed a very sharp CO₂ desorption peak containing over 95% of the sorbed CO₂ (FIG. 9A). This result illustrates that high-purity CO₂ (>95% as shown in FIG. 21) can be obtained from the air in ESA, not being significantly diluted by the purge gas. More beneficial, the module surface temperature did not exceed 40° C. during the vacuum-electrothermal desorption, indicating minor heat loss due to conduction from the surface of the fiber module, which should also be advantageous by requiring less cooling energy (FIG. 9B).

The ETSA processes were further investigated under simulated ambient conditions to explore the feasibility of the modules in more practical DAC environments. For that, simulated air (21% O₂/79% N₂) containing 400 ppm CO₂ was used as the feed gas, replacing the nitrogen-balanced one, and the humidity was also controlled by flowing the inlet gas through a water bath before the module (FIG. 6). The water bath was pre-saturated with 400 pm CO₂ in air to avoid confounding issues associated with CO₂ dissolution into the water during the breakthrough experiment. The adsorption/electrothermal desorption cycles were conducted in dry, wet, and pre-hydrated conditions, as shown in FIG. 9. The module showed the typical ETSA adsorption and desorption curves under the dry air condition and the same CO₂ adsorption capacity as the inert dry conditions (FIG. 9A). Over 95% CO₂ was obtained during regeneration in 7 minutes without water (FIG. 9B). 21% oxygen in the feed did not noticeably change the CO₂ adsorption of the modules.

However, the presence of water vapor in the feed (99% RH) had a significant effect on the CO₂ adsorption behavior. In the wet adsorption, where the CO₂ and water vapor simultaneously flowed into a dry module, both water and CO₂ showed breakthrough curves (FIG. 9C). Water showed a breakthrough much earlier than CO₂ , and its concentration gradually increased after the breakthrough. On the other hand, CO₂ exhibited a unique adsorption behavior-a two-step breakthrough-in which the concentration slowly increased to C/C₀˜0.2 until the water level reached C/C₀˜0.8 and then rapidly saturated. With a definition of breakthrough as C/C₀=0.05, the q_{b} from the humid adsorption was 0.15 mmol/g_{fiber}, which was half of the dry adsorption. However, the overall CO₂ adsorption at pseudo-equilibrium, qₚₑ, was 1.0 mmol/g_{fiber}, more than double the dry adsorption. This is well-known in the area of amine-based CO₂ capture, as the CO₂-amine reaction stoichiometry can change in the presence of water and water may facilitate faster gas transport through the polymer domains, enhancing amine efficiency even when the dominant adsorption mechanism does not change. The adsorbed CO₂ and water were desorbed by the Joule heating of the fiber (FIG. 9D). The CO₂ desorption peak was still sharp and narrow; however, it showed an asymptotic distribution with a long tail, as observed in a previous report. As a result, 65% of the CO₂ was desorbed quickly (<5 minutes), while 30% of residual CO₂ was slowly regenerated after the main peak over an additional 15 minutes such that it took 19 minutes for 95% desorption.

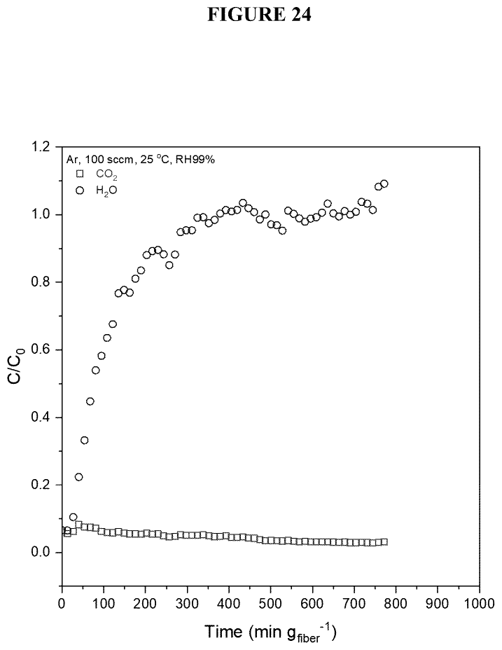

Lastly, the module was pre-hydrated with humid argon (99% RH) before the wet CO₂/Air feed (FIG. 24). In the pre-hydrated adsorption, the module showed a stable and delayed CO₂ breakthrough at around 550 min/g_{fiber}, since the CO₂ could consistently adsorb on the hydrated PEI within the wet sorbent layer under the equilibrium state of the water vapor (FIG. 9E). Consequently, the module exhibited three-fold higher q_{b} and qₚₑ of 0.88 and 1.21 mmol/g_{fiber}, respectively, compared to the dry process. The pre-hydrated adsorption showed similar CO₂ qₚₑ but six times higher q_{b} relative to the wet adsorption. The following electrothermal desorption also presented a long tail of residual CO₂ regeneration after the high concentration peak, suggesting two different adsorption modes in the wet sorbent-coating layer (FIG. 9F). It took 10 minutes for 77% desorption, and 21 minutes for 95% CO₂ desorption.

In this invention, sorbent-coated carbon fibers were prepared by roll-to-roll coating carbon fibers with CA/silica followed by PEI impregnation. The resulting fibers showed dual-layered structures in which carbon fibers at the core were uniformly covered with porous sorbent coating layers. The sorbent-coated carbon fibers exhibited rapid Joule heating behavior, driven by modest 7 V electric potentials, reaching CO₂ desorption temperatures (80-120° C.) within a minute. The sorbent coating layer, when removed from the fiber, showed stable adsorption/desorption cyclic performance with constant CO₂ uptake of 0.48±0.02 mmol/g under 400 ppm CO₂. DAC modules were fabricated with the sorbent-coated carbon fibers and they showed CO₂ breakthrough capacities of ˜0.30 and ˜0.88 mmol/g_{fiber} in dry and pre-hydrated adsorption conditions, respectively. Approximately 95% of the adsorbed CO₂ was obtained ruing regeneration in <10 min/g_{fiber} by electrothermal desorption, which was six times faster than thermal desorption. The module surface temperature did not exceed 50° C. during Joule heating of the fibers to ˜110° C., indicating efficient heat management during the electrothermal desorption and potentially reducing cooling energy. The vacuum-electrothermal desorption exhibited a more intensive CO₂ concentration peak and less increased module surface temperature compared to the electrothermal desorption. In addition, when CO₂ was adsorbed in humid conditions, asymptotic CO₂ desorption peaks with long tails were observed from the electrothermal desorption, likely due to the CO₂ reacting with the adsorbed water. Overall, efficient ESA performance of the sorbent-coated carbon fiber modules was demonstrated by the breakthrough system under various DAC conditions—400 ppm CO₂ with different feed flow rates, balance gases, and humidity.

Table 2 lists exemplary, but non-limiting, components that may be used to prepare the fibers and modules described herein.

TABLE 2

| | Electrically | | | |
|---|---|---|---|---|
| | Conductive | | | |
| Layer | Core | CO₂ Adsorptive Coat | | |
| Component | Carbon Fiber | Polymer | Porous | Adsorbent |
| | | | Additive | |
| | | | (Support for | |
| | | | Adsorbent) | |
| General | Any commercial | Any soluble | Any | A mine-based adsorbent |
| Material | or synthesized | polymers | mesoporous | |
| | carbonaceous | | material | |
| | fiber (CF) | | (pore | |
| | | | diameters of | |
| | | | 2-50 nm) | |
| Non- | Polyacrylonitrile | Cellulose | Silica | Poly(ethyleneimine) |
| Limiting | (PAN) CF | | (commercial, | (PEI) |
| Examples | | | C803, SBA - | |
| | | | 15, MCM - | |
| | | | 41, fumed) | |
| | Activated CF | Cellulose | Alumina (γ- | Diethylenetriamine |
| | | acetate (CA) | alumina) | (DETA) |
| | Multi-walled | Polyimide (PI) | Silica | A minopropyl |
| | Carbon | | Mesocellular | organosilanes (APS) |
| | nanotube fiber | | Foam | |
| | | | (MCF) | |
| | Single-Walled | Polyamide (PA) | Metal- | Tetraethylenepentamine |
| | Carbon | | Organic | (TEPA) |
| | nanotube fiber | | Frameworks | |
| | | | (MOF) | |
| | Silicon carbide | Polysulfone | Zeolite | Ethylenediamine (EN) |
| | fiber | (PSf) | | |
| | | Polyethersulfone | Zeolitic | N,N′- |
| | | (PES) | Imidazole | dimethylethylenediamine |
| | | | Frameworks | (MMEN) |
| | | | (ZIF) | |
| | | Polyvinylidene | Covalent | Poly(allylamine) (PAA) |
| | | fluoride (PVDF) | Organic | |
| | | | Frameworks | |
| | | | (COF) | |
| | | | | diethylenetriamino |
| | | | | organosilanes (DT) |
| | | | | aziridine in situ |
| | | | | polymerization (AZ) |
| | | | | methylaminopropyl |
| | | | | organosilanes (MAP) |
| | | | | ethylenediamine |
| | | | | organosilanes (ED) |

### EXAMPLES

### Materials

A roll of carbon fiber tow (UT-CF-3K, 4.4 lb) was obtained from ACP Composite Inc. (Livermore, CA, USA) for Joule heating media. Cellulose acetate (MW ˜50,000 Da, Sigma-Aldrich Inc.), mesoporous silica (SYLOID® C-803, Grace Davison Inc.), and poly(vinylpyrrolidone) (MW ˜40,000 Da, Sigma-Aldrich Inc.) were thoroughly dried at 110° C. for at least 12 hours in vacuum oven before the coating dope preparation. Branched poly(ethylenimine) (PEI, MW ˜800) was purchased from Sigma-Aldrich for CO₂ adsorbent impregnated on the silica coating layer. N-Methyl-2-pyrrolidone (NMP, Reagent Plus, 99%) was obtained from Sigma-Aldrich, and methanol (ACS Reagent, 99.8%) and n-hexane (ACS Reagent, >98.5%) were purchased from VWR.

### Preparation of Sorbent-Coated Carbon Fibers

The sorbent-coated carbon fibers were fabricated by dip-coating the neat carbon fibers into a silica-containing polymer dope. The coating dope was prepared following previous formulations used to spin sorbent fiber^{33,34} but with a different optimized composition for dip-coating methods (Table 3). A prime dope and a silica dispersion mixture were made separately and mixed together to obtain the coating dope. For the prime dope preparation, 5.22 g of cellulose acetate (CA) was dissolved into 75.8 g of N-methylpyrrolidone (NMP) and 31.2 g of deionized (DI) water, and the mixture was kept on a roller under an IR lamp until a homogeneous solution was formed. For the silica dispersion mixture, 19 g of C803 mesoporous silica was added into 202.2 g of NMP and 83.5 g of DI water, and the mixture was mechanically stirred for three hours. The dispersion was further homogenized with a probe sonifier (Branson 250) for an additional hour. The 74.9 g of the prime dope was added to the silica dispersion mixture, followed by 13.9 g of CA and 6.4 g of poly(vinylpyrrolidone) (PVP). The system was vigorously stirred for another three hours and kept on the roller with heat overnight. The obtained dope for carbon fiber dip-coating was a viscous and foggy white dispersion.

TABLE 3
Dope Composition for Carbon Fiber Dip-Coating
Composition (wt. %)

| CA | PVP | C 803 | NMP | DI |
|---|---|---|---|---|
| 4.3 | 1.6 | 4.7 | 63.2 | 26.1 |

Hand dip-coating was conducted on the carbon fibers for preliminary examination of the coating dope properties (e.g., adhesion, thickness, drying rate). Approximately 10 cm of carbon fibers were completely immersed in the coating dope and pulled out slowly with tweezers, and excessive solution at the fiber surface was gently removed. The wet carbon strands were soaked into a DI water bath to induce phase inversion of the silica-loaded dope. The sorbent-coated carbon fiber was stored in fresh DI water for three days to complete the phase inversion, followed by continuous solvent exchange with methanol and n-hexane for three hours each, then air drying.

### Impregnation of Poly(Ethyleneimine) in the Sorbent-Coated Carbon Fibers

PEI impregnation in the sorbent-coated carbon fibers was conducted following the post-spinning PEI infusion methods described by Labreche et al. (Post-spinning infusion of poly (ethyleneimine) into polymer/silica hollow fiber sorbents for carbon dioxide capture. Chemical engineering journal 221, 166-175, 2013). First, the sorbent-coated carbon fibers were soaked in methanol to fill the pores at the coating layers. Then the pre-saturated fibers were transferred to PEI/MeOH solution and kept for 12 hours to complete PEI impregnation. The PEI concentration was varied between 5-20 wt. %, and the total amount of PEI in the solution was set to be more than ten times over the total weight of C803 in the fibers to minimize concentration change during the PEI loading. After the impregnation, the PEI-loaded fibers were washed with hexane to remove the unloaded PEI, followed by 1-hour air drying and 2-hour vacuum drying at 100° C.

### Joule Heating of the Sorbent-Coated Carbon Fibers

Direct current (DC) voltage was applied by a DC power supply (30 V 10A) to the carbon fibers or the sorbent-coated carbon fibers to measure the electric resistance and Joule heating temperature. The carbon fibers were cut into specific lengths, and both ends were connected to the power supply with alligator clips. The surface temperature was measured by a calibrated thermal imager (ACEGMET, IP65). The electric potential was strictly controlled to not allow the fiber surface temperature to exceed 300° C. The Joule heating temperature under constant DC voltage was measured after the fiber held its peak point for more than 30 seconds. Additionally, the effect of the configuration of the carbon fibers on Joule heating behavior was investigated with different fiber lengths and number of fibers.

### Characterization

A field-emission scanning electron microscopy (FE-SEM, Hitachi 8010) was used to observe the morphologies of sorbent-coated carbon fibers. The fiber samples were cut in liquid nitrogen for cross-sectional SEM images. All the samples were coated with gold particles for 30 seconds using a Hummer 6 sputter coater.

Thermogravimetry analysis (TGA) was utilized to investigate CO₂ uptake and cyclic adsorption/desorption stability of the PEI-loaded coating layers. Specifically, TGA Q-500 (TA Instruments, DE, USA) was used for adsorption capacities under pure CO₂ at 30° C. The sorbent layer sample was mechanically delaminated from the sorbent-coated carbon fibers by hand and subsequently activated at 110° C. for 2 hours under a flowing nitrogen atmosphere at a 10° C./min heating rate. Then, the sample was equilibrated to 30° C. with a 20° C./min cooling rate. The sample gas flow was changed to 50 sccm of pure CO₂ for 2 hours while the mass changes of the samples were monitored.

TGA Q-550 (TA Instruments) with a CO₂/H₂O analyzer (LI-850, Li-Cor, NE, USA) was used for gas uptake and cyclic adsorption/desorption under 400 ppm CO₂. For the 400 ppm CO₂ adsorption uptake experiments, the sorbent layer was activated at 110° C. under a nitrogen atmosphere until the CO₂ level in the Li-Cor detector went below 10 ppm, followed by flowing 400 ppm CO₂ in N₂ for 24 hours at 30° C. For cyclic stability, ten cycles of adsorption/desorption were conducted under the 400 ppm CO₂ condition, where adsorption and desorption temperatures were 30° C. and 110° C., respectively. The CO₂ level at steady state, however, was ˜50 ppm lower than the feed concentration (400 ppm). We speculate this difference was from both or either the CO₂ detection error and/or CO₂ concentration error of the gas cylinder. However, as a 400 ppm CO₂ cylinder was used for both the sample and balance purge during adsorption, the sample was under the same gas composition of the cylinder we used.

### Fabrication of DAC Modules

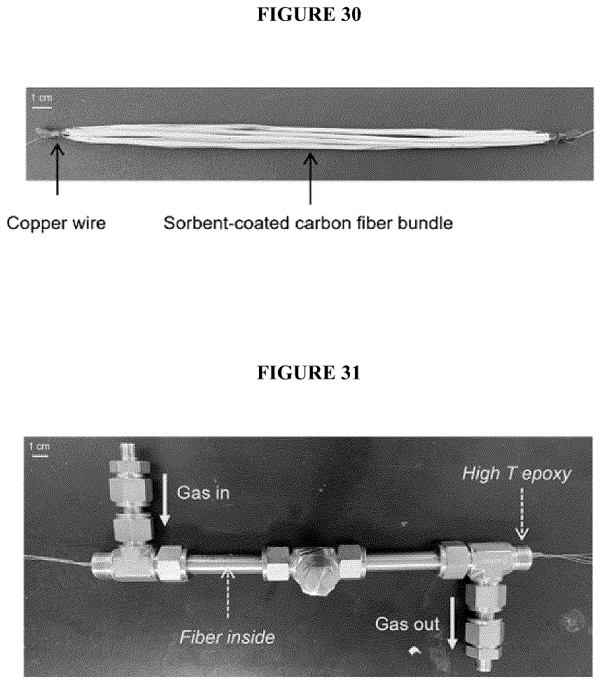

The DAC modules for carbon capture applications were made of a sorbent-coated carbon fiber bundle. After PEI impregnation, the fibers were cut into 11 inch segments, and one inch of the sorbent coating layers were peeled off from both ends of the fiber to expose conductive carbon. Then, 3-6 strands of the fibers were collected, and the carbon ends of the bundle were tied with copper wires (FIG. 30). The wire-connected bundle was placed into a stainless tube with gas flow lines at either end of the tube. The ends of the module were thoroughly sealed with high-temperature epoxy (8272 MarineWeld Epoxy, JB Weld Company, TX, USA) to prevent gas leakage (FIG. 31). This tubular design with extraneous fittings is unlikely to be suitable for real DAC deployment due to frictional losses in the fittings but is a workable test system to understand the ETSA performance of the sorbent-coated carbon fibers.

### Roll-to-Roll Coating of the Carbon Fibers

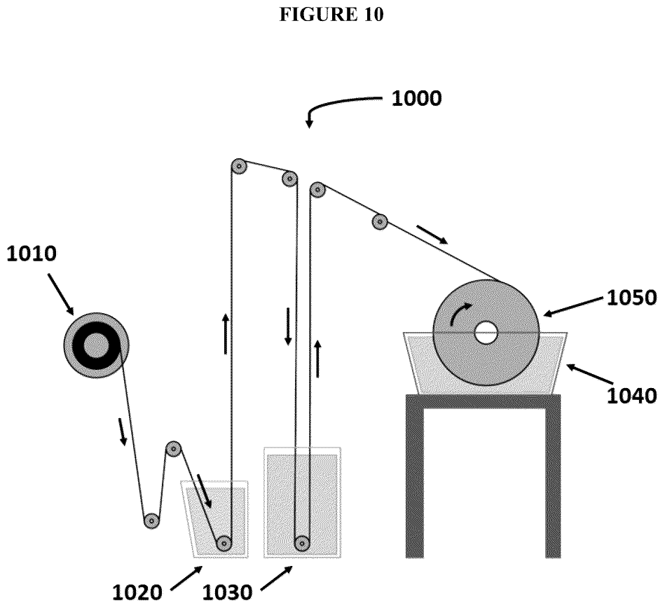

Carbon fiber dip-coating has been scaled using a roll-to-roll coating system 1000 as illustrated in FIG. 10. In the roll-to-roll coating system 1000, carbon fiber moves with the aid of a plurality of rolling pulleys from a carbon fiber spool 1010 to a dope container 1020, then to a water coagulation bath 1030, and finally to a take up bath 104 where the finally formed sorbent-coated fibers are collected on spool 1050. The thickness of the coating layer and phase inversion time were controlled by the take-up winding speed, which ranged from 200 mm/min to 3000 mm/min. The dip-coating was achieved when the uncoated carbon fibers passed through the dope container filled with the sorbent dope, and then the carbon fibers traveled along a long vertical pathway to drain gravimetrically the excessive dope from the fiber surface back into the dope container. Then, the carbon fibers were immersed in the coagulation bath filled with DI water for phase inversion of the dope into the solid sorbent coating layer. Lastly, the sorbent-coated carbon fiber bundles were taken out of the take-up bath and soaked in water for three days, followed by continuous washing with methanol for 3 hours and n-hexane for 3 hours to complete phase inversion and solvent exchange. The fiber bundles were dried and stored in ambient conditions before use. The weight fraction of the sorbent layer over the resulting sorbent-coated carbon fiber was obtained from the mass change after the dip-coating, following Equation 1.

$${w}_{s} = \frac{{m}_{s c}}{{m}_{c}} - 1 \qquad ( 1 )$$

where the weight faction of the sorbent layer (wₛ) was calculated from the mass of the sorbent-coated carbon fiber (m_{sc}) and the carbon fiber (m_{c}).

### Dynamic Gas Adsorption and Desorption

Dynamic gas adsorption/desorption tests were conducted using a lab-made breakthrough apparatus (FIG. 6 and FIG. 17). UHP (ultra-high purity) grade argon and 400 ppm CO₂ in nitrogen (or air) were used for desorption and adsorption feed, respectively. Gas flow rates were regulated by mass flow controllers (MFC, FMA 5400A/5500A, Omega), and flow directions were controlled by three-way valves. The humidity in the feed was generated by flowing gas through a saturator and demister containing water and glass fibers, respectively, in front of the module inlet. In contrast, the feed gas did not pass the saturator for dry experiments. The humidity at the inlet and outlet of the module was monitored by temperature-hygrometer (THM, DWEII, measurement range: 10-99 % RH, ±5% RH; −50-70° C., ±1° C.). The module center was connected to a vacuum pump, and a temperature indicator (TI) probe contacting to the fiber bundle. At the ends of the module, copper wires were connected to the DC power supply for electric energy desorption. Gas compositions after the module were in-situ recorded by mass spectroscopy (Omnistar Quadrupole mass spectrometer, QMG 220, Pfeiffer Vacuum, Asslar, Germany).

### Adsorption

Before the initial breakthrough measurements, the module was activated at 110° C. flowing 100 sccm of dry argon to desorb the pre-adsorbed gases until N₂, O₂, H₂O, and CO₂ signals became stable at the minimum. Then, the heat was turned off, and the system was cooled to room temperature using an auxiliary fan blowing on the exterior of the module. In this study, three different adsorption modes were operated subject to humidity controls: (i) dry adsorption, (ii) wet adsorption, and (iii) pre-hydrated adsorption. For the dry adsorption, the nitrogen or air containing 400 ppm CO₂ directly flowed into the shell side of the module maintaining dry (0% RH) system. On the other hand, for the wet adsorption, the feed gas passed through the saturator prior to the module, providing 99% RH flow. In the pre-hydrated adsorption, the module was pre-saturated with water by flowing humid argon, followed by the adsorption stage with wet 400 ppm CO₂. When applying humid flows into the module, the feed gas flowed through the water bath at least 10 minutes after humidity reached 99% to pre-saturate the feed flow and the water bath and then connected to the module.

Breakthrough capacity (q_{b}, mmol/g) and pseudo-equilibrium capacity (qₚₑ, mmol/g) was calculated from the integrated areas of the breakthrough curves until the normalized CO₂ concentration (C/C₀) reaches 0.05 and 0.95, respectively, following Equations 2A and 2B.

$${q}_{b} = \frac{{C}_{0} Q}{{V}_{m} M} {\int }_{0}^{{t}_{b}} ( 1 - C / {C}_{0} ) dt \qquad ( 2 A )$$

$${q}_{p e} = \frac{{C}_{0} Q}{{V}_{m} M} {\int }_{0}^{{t}_{0.95}} ( 1 - C / {C}_{0} ) dt \qquad ( 2 B )$$

where Vₘ (cm³(STP)mol⁻¹) and M(g) indicate the molar volume and sample weight, and t_{b} (min) and t_{0.95} (min) are adsorption time for breakthrough and pseudo-equilibrium, respectively.

### Desorption

Once the breakthrough curves reached adsorption equilibrium, three different desorption conditions were evaluated: (i) externally-driven thermal desorption, (ii) electrothermal desorption, and (iii) vacuum-electrothermal desorption, which correspond to TSA, ETSA, and VETSA system, respectively.

### Externally-Driven Thermal Desorption

The module was covered by heating tape and aluminum foil to minimize heat losses (FIG. 17). The module surface was heated to 110° C., while argon gas flowed across the fiber samples. When CO₂ concentration from the module decreased to the baseline, the thermal desorption was terminated. For the following adsorption step, the module was cooled to room temperature using an auxiliary fan, and then the aluminum foil and the heating tape were removed.

### Electrothermal Desorption

The copper wires from the module were connected to the DC power supply (FIG. 6). A specific electric potential that was based on a pre-determined voltage to achieve 110° C. fiber temperature was applied to the module along with argon flow. The electrothermal desorption step was maintained until the CO₂ mass signal reached equilibrium. After that, the electric potential was disconnected, and the module was naturally cooled to room temperature without any cooling accessories.

### Vacuum-Electrothermal Desorption

The module was isolated from the feed gas by closing the ball valves at the inlet and outlet, and the needle valve between the module and the vacuum pump opened. The pump pulled the vacuum for ˜10 s and disconnected from the module (FIG. 6). The DC power was applied for a specific time to regenerate CO₂ under negative pressure. The module was then opened, and argon was flowed to sweep out the CO₂. Like the electrothermal desorption, the module returned to room temperature by natural cooling.

### Wind Energy DAC (WEDAC) Modules

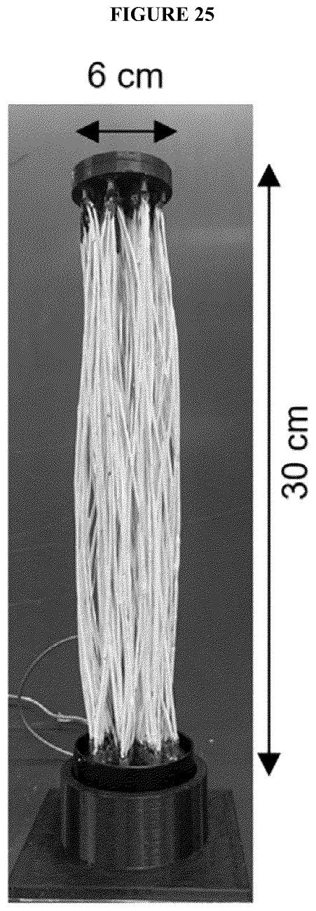

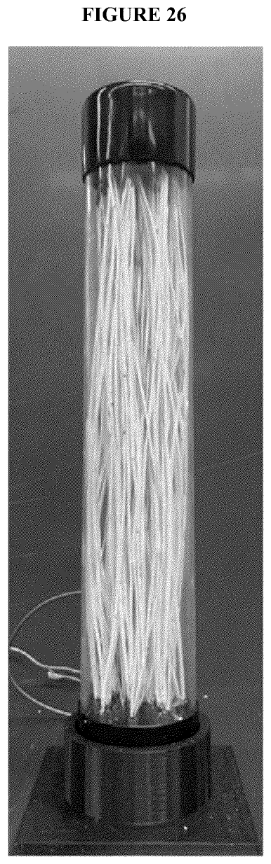

In this example, the DAC modules described above were scaled up 20×to capture the CO₂ from ambient air in a WEDAC process. 120 sorbent-coated carbon fibers (each 30 cm in length) were vertically aligned inside a removable vacuum casing. The fibers were individually separated from the center support structure. The modules had 6 g of sorbent-coated carbon fibers. The vacuum case was made of two rubber covers and a Ø6×30 cm clear acrylic tube. The rubber covers enveloped the acrylic tube, sealing the inner space of the cylinder. FIG. 25 is an image of a WEDAC module in the open configuration for the adsorption of CO₂. FIG. 26 is an image of the WEDAC module of FIG. 25 in the closed configuration, (i.e., fibers encased in the clear acrylic tube) for the vacuum-assisted electrothermal desorption of CO₂.

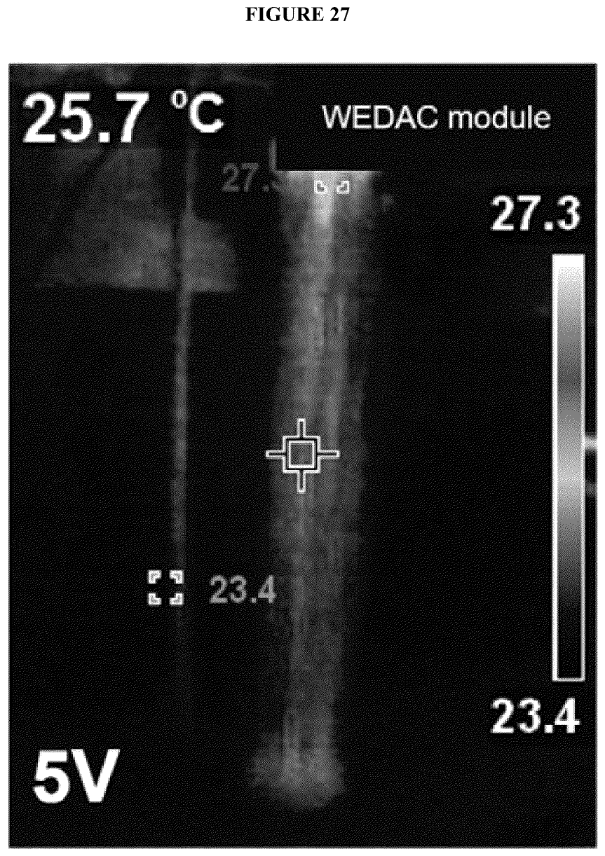

All fibers were observed to exhibit approximately uniform Joule heating behavior, reaching the desorption temperature at 5 V in 3 min. FIG. 27 is a thermal image of the WEDAC module of FIG. 25 in the open configuration at 25.7° C. and 5V for 3 minutes. FIG. 28 is a thermal image of the WEDAC module of FIG. 25 in the open configuration at 73.6° C. and 5V for 3 minutes.

A WEDAC experimental setup was implemented for ETSA operation. In an open and windless space (a laboratory), the module stood vertically at a specific distance from the fan. The bottom of the adsorption body was connected to an electric power supply. The top of the vacuum case was continuously linked to a micropump (DC 12 V 12 W, micro diaphragm pump air compressor, max. −75 kPa, 12 LPM) and gas sampling bag. The WEDAC process consists of adsorption/desorption cycles. For the ambient air CO₂ adsorption, the module in the open configuration, and the fan blew air across the laboratory towards the fibers at a controlled wind speed and blowing time. After a period of time, the WEDAC module was converted to the closed configuration by enclosing the fibers within the vacuum case, residual air was pumped out, and then an electric potential was applied on the module with the vacuum for desorption. The vacuum level was 0.3 bar. Then, 5 V of electric potential was applied to the module for the electrothermal desorption. Once the gas sampling bag stopped being inflated, the power was turned off and module was cooled. Then, the gas bag was replaced, the pump was turned off, and the module was returned to the open configuration for a subsequent adsorption step. The CO₂ purity in the gas sampling bag was measured by a CO₂ analyzer (Model 906, Quantek Instrument, MA, USA).

For adsorption, fan-generated wind was blown through the module at a wind speed of 3 m/s, where the wind speed ratio at the front and back of the module was observed to be 0.21 (i.e., the average air velocity within the module is at least 21% of the windward side air velocity). These modules were electrothermally regenerated with a weak vacuum pump (i.e., no flowing inert gases). These prototype modules were able to generate a 81.5 mol % concentrated CO₂ product without dilution from the ambient air (<400 ppm CO₂) in 10 min of Joule heating under a 0.3 bar vacuum in the laboratory.

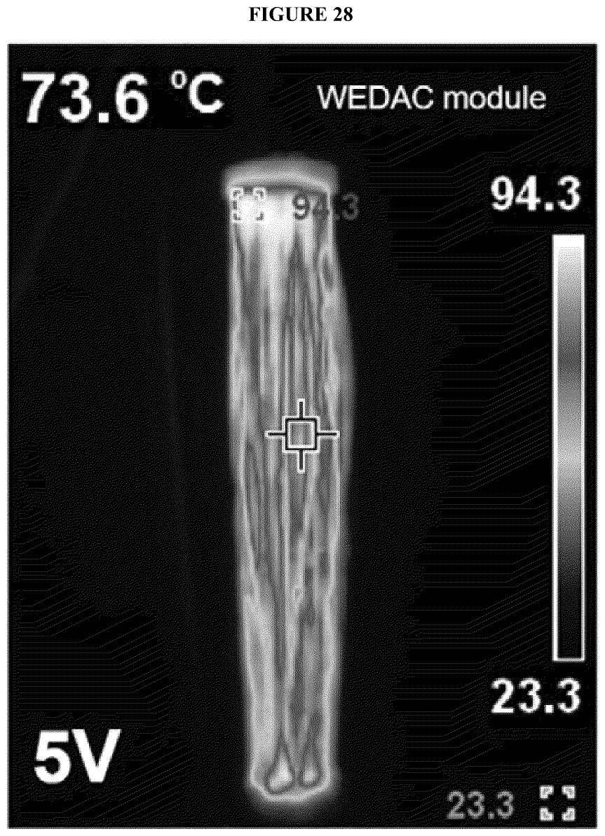

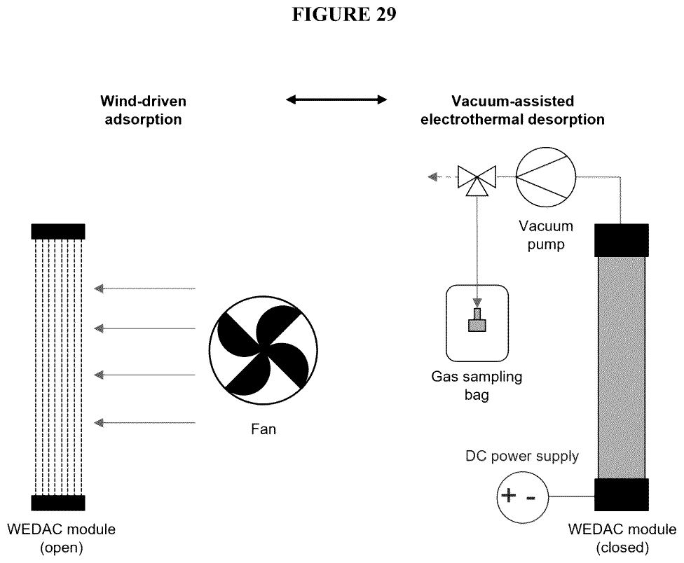

FIG. 29 is a schematic illustration of the use of a WEDAC module in the open configuration for the adsorption of CO₂ , followed by transitioning the WEDAC module to the closed configuration for the vacuum-assisted electrothermal desorption of CO₂.

### Techno-Economic Analysis of a Pilot-Scale WEDAC System

A passive wind-driven cylindrical contactor with a diameter of 6 cm and a height of 1 m was studied. The contactor was uniformly filled with PEI-coated carbon fibers. This system could be set in a moderately windy location (wind speed is assumed to be 3 m/s) for adsorption. Joule heating from external power supply with the aid of vacuum was implemented during desorption process. An insulation coat was implemented during desorption to reduce the convective heat loss to the surroundings by convection from the surface of the cylinder. After desorption, the system was cooled down in natural wind where it is assumed the insulation can be withdrawn but the system is still sealed by a thin impermeable fabric. A full cycle includes adsorption, desorption, and cooling processes. The detailed parameters used in this TEA analysis are listed in Table 4.

| Parameter | Symbol | Value | Unit |
|---|---|---|---|
| Contactor installation cost | C_{c} | 60 | $/kg_{contactor} |
| Heat capacity of CO2 | C_{p, g} | 849 | J /(kg · ° C.) |
| Heat capacity of contactor | C_{p, s} | 1100 | J /(kg · ° C.) |
| solid | | | |
| Sorbent dope's cost | Cₛ | 2 | $/kg |
| Vacuum pump purchase cost | Cᵥ | 125 | $ |
| Wind power cost | C_{wind} | 0.03 | $/kWh |
| Contactor diameter | D_{c} | 6 | cm |
| Fiber diameter | D_{f} | 1 | mm |
| Contactor porosity | ε_{c} | 0.909 | — |
| Joule heating input during | Eⱼₒᵤₗₑ | 7.2 (ETSA)/75.7 | GJ tCO₂⁻¹ |
| desorption | | (External heating | |
| Bare module factor | fbm | 3.05 | — |
| CO2 adsorption heat | ΔH_{ads} | −65.6 | kJ/mol |
| Contactor height | H_{c} | 1 | m |
| Contactor material's lifetime | L_{c} | 10 | yr |
| Sorbent lifetime | Lₛ | 0.5 | yr |
| Vacuum pump's lifetime | Lᵥ | 10 | yr |
| Contactor mass | M_{c} | 0.35 | kg |
| Number of contactors | N | 15 (ETSA)/3 (External | — |
| sharing a vacuum pump | | heating) | |
| Cycles per year | N_{cycle/yr} | 8375 (ETSA)/5677 | — |
| | | (External heating) | |
| Vacuum pump efficiency | η | 50 | % |
| Ambient pressure | P | 1 | atm |
| Vacuum degree during | P₀ | 0.05 | atm |
| desorption | | | |
| CO2 annual productivity | Prₐ | 0.2 (ETSA)/0.08 | tCO₂/(kg · yr) |
| | | (External heating) | |
| Swing capacity | q_{w} | 0.54 (ETSA)/0.32 | mol/kg_{contactor} |
| | | (External heating) | |
| Adiabatic compression factor | Υ | 1.3 | — |
| of CO2 | | | |
| Desorption time per cycle | t_{des/cycle} | 10 (ETSA)/600 (External | sec |
| | | heating) | |
| Temperature difference | ΔT | 110 (ETSA)/100 | ° C. |
| between desorption and | | (External heating) | |
| adsorption | | | |
| Desorption temperature | T_{des} | 140 (ETSA)/130 | ° C. |
| | | (External heating) | |
| Wind speed | U₀ | 3 | m/s |
| Weight ratio of pure fibers | W_{c} | 0.5 | — |
| over coated fibers | | | |
| Weight ratio of pure fibers | Wₛ | 0.5 | — |
| over coated fibers | | | |

The overall cost of the DAC system includes capital costs, fixed operating and maintenance costs, and variable operating and maintenance costs. The capital costs included contactor capital cost, vacuum pump capital cost, and indirect capital costs. Fixed operating and maintenance costs were assumed to be 5% of the total capital cost. Variable operating and maintenance costs include sorbent operating cost, Joule heating operating cost and vacuum pump operating cost, which is mostly the cost of electricity for the latter two components. The contactor capital cost is given by Equation (3):

$$Contractor capital cost ( \$ {t CO}_{2}^{- 1} ) = \frac{{C}_{c} {w}_{c}}{{L}_{c} {Pr}_{a}} \qquad ( 3 )$$

where C_{c} ($) represents the installation cost of the contactor, including material cost and infrastructure cost related to contactor base, shell, and carbon fibers, and was estimated to be 60 $/kg_{contactor}; w_{c} represents the weight ratio of the carbon fibers over the coated fibers, and was estimated to be 0.5; L_{c} (yr) represented the lifetime of the contactor materials, and was estimated to be 10 years; and Prₐ (tCO₂/(kg·yr)) was the annual productivity of DAC system, and was estimated based on the simulated cycle behaviors using a 2 d computational fluid dynamic (CFD) model and a 2 d process model under given operating conditions.

Vacuum pump capital cost is given by Equation (4):

$$Vacuum pump capital costs ( \$ {t CO}_{2}^{- 1} ) = \frac{fbm \times {C}_{v}}{{NL}_{v} {Pr}_{a} {M}_{c}} \qquad ( 4 )$$

where fbm represented the bare module factor of the vacuum pump; Cᵥ ($) represents the purchasing cost of vacuum pump, which was determined by the system size, vacuum degree and maximum flow rate; N represents the number of contactors sharing the vacuum pump, considering the ratio of adsorption and cooling periods over desorption period was larger than four at most operating conditions, N was set to be 5; Lᵥ (yr) represents the lifetime of the vacuum pump, and was estimated to be 10 years; and M_{c} (kg) represents the mass of the contactor, which was estimated 0.909.

Indirect capital cost is related to the annual production of a plant and the energy input per ton CO₂. Assuming our DAC system could capture 1 million ton CO₂ per year, the indirect cost was estimated to be 30 $/tCO₂.

Sorbent operating cost is given by Equation (5):

$$Sorbent operating cost ( \$ {t CO}_{2}^{- 1} ) = \frac{{C}_{s} {w}_{s}}{{L}_{s} P {r}_{a}} \qquad ( 5 )$$

where Cₛ ($/kg) represents the sorbent dope material cost, and was estimated to be 2 $/kg_{contactor}; wₛ represents the mass ratio of the sorbent over the coated fibers, and Lₛ (yr) represents the lifetime of the sorbent, and was estimated to be 0.5 years.

Vacuum pump operating cost is given by Equations (6A-D) assuming adiabatic compression:

$$( 6 A )$$

$$Vacuum pump operating cost ( {t CO}_{2}^{- 1} ) = \frac{\frac{PV - {P}_{0} {V}_{0}}{Υ - 1}}{η} \times \frac{{N}_{cycle / yr} {t}_{des / cycle}}{{M}_{a} P {r}_{a}} \times {C}_{wind}$$

$${PV}^{Υ} = {P}_{0} {V}_{0}^{Υ} \qquad ( 6 B )$$

$${V}_{0} = \frac{{nRT}_{des}}{{P}_{0}} \qquad ( 6 C )$$

$$n = \frac{{M}_{a} {q}_{w}}{{t}_{des / cycle}} \qquad ( 6 D )$$

where P (atm) represents the ambient pressure, 1 atm; P₀ (atm) represents the vacuum degree during desorption, which was 0.05 atm; V (m³) represents the volume of the extracted CO₂ at 1 atm; V₀ (m³) represents the volume of the extracted CO₂ at P₀, and was calculated based on the transient desorption rate of CO₂ (Equations 7C and D); γ represents the adiabatic compression factor of CO₂ , and was estimated to be 1.3; η represents the pump efficiency, and was assumed to be 50%; N_{cycle/yr} represents the operating cycles per year; t_{des/cycle} (hr) represented the desorption time per cycle; C_{wind} ($/Wh) represents the cost of wind power, which was assumed to be 0.03 $/kWh; T_{des} (° C.) represents the average temperature of the fibers during desorption; R represents the gas constant; and q_{w} (mol/kg) represents the swing capacity per cycle.

Joule heating operating cost is given by Equation (7A):

$$Joule heating operating cost ( {t CO}_{2}^{- 1} ) = {E}_{Joule} \times {C}_{w i n d} \qquad ( 7 A )$$

where E_{Joule} (GJ tCO₂⁻¹) represents the Joule heating input during desorption for capturing one ton of CO₂. Joule heating input energy was converted to four parts, including CO₂ desorption heat (Equation 7B), CO₂ sensible heat (Equation 7C), contactor sensible heat (Equation 7D) and forced convective heat loss from the surface of the device during desorption (the remaining heat):

$$CO 2 desorption heat ( \frac{GJ}{t CO 2} ) = \frac{Δ {H}_{ads}}{{M}_{w , CO 2}} \qquad ( 7 B )$$

$$CO 2 sensible heat ( \frac{GJ}{t CO 2} ) = {C}_{p , g} Δ T \qquad ( 7 C )$$

$$contractor sensible heat ( \frac{GJ}{t CO 2} ) = \frac{{C}_{p , s} Δ T}{{Pr}_{a}} \times {N}_{cycle / yr} \qquad ( 7 D )$$

where ΔH_{ads} (kJ/mol) represented the adsorption heat of CO₂ onto PEI loaded carbon fibers, −65.6 kJ/mol; M_{w,CO2} (kg/mol) represented the molar mass of CO₂; C_{p,g} (J/(kg·° C.)) represented the heat capacity of CO₂, 849 J/(kg·° C.); ΔT (° C) represents the temperature difference between desorption and adsorption processes; and C_{p,s} (J/(kg·° C.)) represents the heat capacity of the contactor, 1100 J/(kg·° C.).

A techno-economic analysis of a pilot-scale WEDAC system was conducted by considering a comparison between direct and indirect ETSA (direct ETSA refers to heating the carbon fiber cores, while indirect ETSA refers to heating the contactor surface, both with electric energy) with either wind power (0.03 $ kWh⁻¹) or US grid power (0.06 $ kWh⁻¹). The overall cost includes capital costs (capex) of the contactor; vacuum pump and indirect cost; fixed operating and maintenance cost (fixed O&M ex); and variable operating costs (opex) of the sorbent, vacuum pump, and Joule heating. In general, Joule heating opex was the major contributor of the overall cost, followed by vacuum pump capex. The overall cost was projected to be approximately 160 $ tCO₂⁻¹ with direct ETSA driven by renewable electricity (we assumed wind energy in our analysis as co-location of the DAC module and a wind turbine is likely advantageous). The energy consumption of the ETSA process is dominated by the Joule heating energy input during desorption, which is expected to be approximately 7.2 GJ tCO₂⁻¹ for a full-scale process, given a cycle capacity of 0.54 mol CO₂/kg contactor (1.08 mol CO₂/kg sorbent). Our analysis of the Joule heating energy usage (FIG. 8B) suggests that 5%-10% of the applied energy is lost via convective heat loss to the surroundings. Compared with combinations of vacuum, concentration, and temperature swing processes with indirect heating, the higher annual productivity from the faster desorption process in ETSA can compensate the higher energy costs via significant reductions in the capital costs (e.g., removal of fans, steam equipment, condensers, etc.). We find that the sensible heat of our current Joule heating materials (carbon tow) dominates the energy costs, highlighting a path forward for future research. With US grid power, the overall cost increased by about 40% relative to the wind power to 226 $ tCO₂⁻¹ due to the increased cost of electricity. The overall cost for net CO₂ capture would be even higher if we consider the associated carbon emissions of the grid. If indirect/external heating was implemented, the overall cost would increase approximately eight times due to the reduced annual productivity from the longer desorption process and extra convective heat loss to the surroundings. In addition, the number of contactors sharing one vacuum pump is also reduced with increasing desorption time, causing a significant increase in vacuum pump capital expenditures. The energy consumption of ETSA could be further reduced once a higher swing capacity was achieved under a lower temperature swing range.

### Experimental Conclusions

Herein, we demonstrate the feasibility and scalability of ETSA for the DAC system with data from a lab-made DAC system. We explored the application of ETSA to DAC by creating ETSA fiber materials and DAC modules. We have included testing data on an ETSA WEDAC module that is designed to operate in the presence of wind instead of with fans. We also include a techno-economic analysis on this concept to highlight a potential path forward to low-cost DAC. The sorbent-coated carbon fibers were prepared by roll-to-roll coating carbon fibers with CA/silica followed by PEI impregnation. The resulting fibers showed dual-layered structures in which carbon fibers at the core were uniformly covered with porous sorbent coating layers. The sorbent-coated carbon fibers exhibited rapid Joule heating behavior, driven by modest 7 V electric potentials, reaching CO₂ desorption temperatures (80-120° C.) within a minute. The sorbent coating layer, when removed from the fiber, showed stable adsorption/desorption cyclic performance with constant CO₂ uptake of 0.48±0.02 mmol/g under 400 ppm CO₂.

DAC modules were fabricated with the sorbent-coated carbon fibers, and they showed CO₂ breakthrough capacities of about 0.30 and about 0.88 mmol/g_{fiber} in dry and pre-hydrated adsorption conditions, respectively. Approximately 95% of the adsorbed CO₂ was obtained during regeneration in <10 min by electrothermal desorption, which was six times faster than external, indirect thermal desorption. The module surface temperature did not exceed 50° C. during Joule heating of the fibers to about 110° C., indicating efficient heat management during the electrothermal desorption and thus potentially reducing cooling times. The vacuum-electrothermal desorption exhibited a more intensive CO₂ concentration peak and less increased module surface temperature compared with the flowing gas electrothermal desorption. In addition, when CO₂ was adsorbed in humid conditions, asymptotic CO₂ desorption peaks with long tails were observed from the electrothermal desorption, likely due to the CO₂ reacting with the adsorbed water. Overall, efficient ETSA performance of the sorbent-coated carbon fiber modules was demonstrated by the breakthrough system under various DAC conditions −400 ppm CO₂ with different feed flow rates, balance gases, and humidity.

We created DAC modules with a 20× scale-up factor compared with our laboratory devices. These scaled-up DAC modules contain 120 sorbent-coated carbon fibers and can operate without fans in windy environments. The modules adsorbed CO₂ from the ambient air and regenerated concentrated CO₂ by vacuum-assisted electrothermal desorption at productivities and purities (80%-85 mol % CO₂) that are consistent with what we expect based on our fundamental measurements of the coated carbon fiber performance. Importantly, the sorbent-coated carbon fibers were made of all industrial products, including carbon fibers, sorbents, polymers, and silicas, highlighting the potential for shorter commercialization times relative to more exotic materials. Future implementations of such DAC materials can also incorporate thermoelectric materials into the fiber, thus enabling the conversion of adsorption enthalpy to reduce the net power required by this DAC concept.

We have conducted TEA on a pilot-scale passive ETSA WEDAC system. The energy consumption of Joule heating during desorption is 7.2 GJ tCO₂⁻¹. The energy efficiency of this Joule heating approach is potentially promising with only 7% of the total heating being lost convectively to the ambient. The overall cost is expected to be about 160 $ tCO₂⁻¹ in optimal conditions. This ETSA DAC system possesses advantages such as lower capital costs, higher annual productivity from faster desorption process, and lower energy losses, which together contribute to a lower cost.

### The Following References may be Pertinent to the Present Application

1. Sanz-pérez, E. S., et al. (2016). Direct capture of CO₂ from ambient air. Chemical reviews 116, 11840-11876.
2. Breyer, C., et al. (2019). Direct air capture of CO₂: a key technology for ambitious climate change mitigation. Joule 3, 2053-2057.
3. Rim, G., et al. (2022). Sub-Ambient Temperature Direct Air Capture of CO₂ using Amine-Impregnated MIL-101 (Cr) Enables Ambient Temperature CO₂ Recovery. JACS Au 2, 380-393.
4. Sujan, A. R., et al. (2019). Direct CO₂ capture from air using poly (ethylenimine)-loaded polymer/silica fiber sorbents. ACS Sustainable Chemistry & Engineering 7, 5264-5273.
5. Song, M., et al. (2022). Cold-Temperature Capture of Carbon Dioxide with Water Coproduction from Air Using Commercial Zeolites. Industrial & Engineering Chemistry Research.
6. Haertel, C. J. J., et al. (2021). The promise of scalable direct air capture. Chem 7, 2831-2834.
7. Shi, X., et al. (2020). Moisture-driven CO₂ sorbents. Joule 4, 1823-1837.
8. Grande, C. A., et al. (2009). CO₂ capture from NGCC power stations using electric swing adsorption (ESA). Energy & fuels 23, 2797-2803.
9. Wilcox, J. (2020). An electro-swing approach. Nature Energy 5, 121-122.
10. Zhao, Q., et al. (2019). CO₂ capture using a novel hybrid monolith (H-ZSM5/activated carbon) as adsorbent by combined vacuum and electric swing adsorption (VESA). Chemical Engineering Journal 358, 707-717.
11. Regufe, M. J. o., et al. (2020). Development of hybrid materials with activated carbon and zeolite 13× for CO₂ capture from flue gases by electric swing adsorption. Industrial & Engineering Chemistry Research 59, 12197-12211.
12. Zhao, Y., et al. (2022). Rapid joule-heating activation boosted capacitive performance of carbon fibers. Composites Communications 34. 10.1016/j.coco.2022.101263.
13. Lu, M., et al. (2021). Continuous stabilization of polyacrylonitrile (PAN)-carbon nanotube (CNT) fibers by Joule heating. Chemical Engineering Science 236. 10.1016/j.ces.2021.116495.
14. Lu, M., et al. (2020). Structure, properties, and applications of polyacrylonitrile/carbon nanotube (CNT) fibers at low CNT loading. Polymer Engineering & Science 60, 2143-2151.
15. Chien, A.-T., et al. (2014). Electrical conductivity and Joule heating of polyacrylonitrile/carbon nanotube composite fibers. Polymer 55, 6896-6905.
16. Athanasopoulos, N., et al. (2011). Numerical investigation and experimental verification of the Joule heating effect of polyacrylonitrile-based carbon fiber tows under high vacuum conditions. Journal of Composite Materials 46, 2153-2165. 10.1177/0021998311430159.
17. An, H., et al. (2011). CO₂ capture by electrothermal swing adsorption with activated carbon fibre materials. International Journal of Greenhouse Gas Control 5, 16-25.
18. Moon, S.-H., and Shim, J.-W. (2006). A novel process for CO₂/CH₄ gas separation on activated carbon fibers—electric swing adsorption. Journal of colloid and interface science 298, 523-528.
19. Sullivan, P. D., et al. (2004). Activated carbon fiber cloth electrothermal swing adsorption system. Environmental science & technology 38, 4865-4877.
20. Keller, L., et al. (2019). Electrical swing adsorption on functionalized hollow fibers. Chemical Engineering Journal 371, 107-117.
21. Zhao, Q., et al. (2017). Impact of operating parameters on CO₂ capture using carbon monolith by Electrical Swing Adsorption technology (ESA). Chemical Engineering Journal 327, 441-453.
22. Verougstraete, B., et al. (2022). Electrical swing adsorption on 3D-printed activated carbon monoliths for CO₂ capture from biogas. Separation and Purification Technology 299, 121660.
23. Ribeiro, R., et al. (2013). Activated carbon honeycomb monolith—Zeolite 13× hybrid system to capture CO₂ from flue gases employing Electric Swing Adsorption. Chemical Engineering Science 104, 304-318.
24. Quan, W., et al. (2022). Scalable Formation of Diamine-Appended Metal-Organic Framework Hollow Fiber Sorbents for Postcombustion CO₂ Capture. JACS Au.
25. Lee, Y. H., et al. (2021). Controlled Synthesis of Metal—Organic Frameworks in Scalable Open-Porous Contactor for Maximizing Carbon Capture Efficiency. JACS Au 1, 1198-1207.
26. Diederichsen, K. M., et al. (2022). Nondimensional Analysis of a Hollow Fiber Membrane Contactor for Direct Air Capture. Industrial & Engineering Chemistry Research 61, 11964-11976.
27. Wilfong, W. C., et al. (2022). Directly Spun Epoxy-Crosslinked Polyethylenimine Fiber Sorbents for Direct Air Capture and Postcombustion Capture of CO₂. Energy Technology, 2200356.
28. Labreche, Y., et al. (2013). Post-spinning infusion of poly (ethyleneimine) into polymer/silica hollow fiber sorbents for carbon dioxide capture. Chemical engineering journal 221, 166-175.
29. Sholl, D. S., et al. (2022). Exemplar Mixtures for Studying Complex Mixture Effects in Practical Chemical Separations. JACS Au 2, 322-327.
30. Fan, Y., et al. (2014). Evaluation of CO₂ adsorption dynamics of polymer/silica supported poly(ethylenimine) hollow fiber sorbents in rapid temperature swing adsorption. International Journal of Greenhouse Gas Control 21, 61-71.
31. Wijesiri, R. P., et al. (2019). Desorption process for capturing CO₂ from air with supported amine sorbent. Industrial & Engineering Chemistry Research 58, 15606-15618.
32. Didas, S. A., et al. (2014). Effect of amine surface coverage on the co-adsorption of CO₂ and water: spectral deconvolution of adsorbed species. The journal of physical chemistry letters 5, 4194-4200.
33. Labreche, Y., et al. (2014). Poly (amide-imide)/silica supported PEI hollow fiber sorbents for postcombustion CO₂ capture by RTSA. ACS Applied Materials & Interfaces 6, 19336-19346.
34. Labreche, Y., et al. (2013). Post-spinning infusion of poly (ethyleneimine) into polymer/silica hollow fiber sorbents for carbon dioxide capture. Chemical engineering journal 221, 166-175.
   The description of the present embodiments of the invention has been presented for purposes of illustration but is not intended to be exhaustive or to limit the invention to the form disclosed. Many modifications and variations will be apparent to those of ordinary skill in the art. As such, while the present invention has been disclosed in connection with an embodiment thereof, it should be understood that other embodiments may fall within the spirit and scope of the invention. All patents and publications cited herein are incorporated by reference in their entirety.

1. A carbon dioxide (CO₂) capture material, the material comprising:
a carbon-containing fiber; and
a CO₂ adsorptive material coating the carbon-containing fiber.

2. The CO₂ adsorptive material of claim 1, wherein the carbon-containing fiber is a carbon fiber.

3. The CO₂ adsorptive material of claim 2, wherein the carbon fiber is any one of a polymer-derived carbon fiber, an activated carbon fiber, a multi-walled carbon nanotube fiber, a single-walled carbon nanotube fiber, or a silicon carbide fiber.

4. The CO₂ adsorptive material of claim 1, wherein the CO₂ adsorptive material comprises a porous support and an adsorbent material.

5. The CO₂ adsorptive material of claim 4, wherein the porous support is mesoporous.

6. The CO₂ adsorptive material of claim 4, wherein the porous support is a porous silica, a porous alumina, a porous aluminosilicate, a metal-organic framework, a zeolite, a zeolitic imidazole framework, or a covalent organic framework.

7. The CO₂ adsorptive material of claim 4, wherein the adsorbent material is an amine-based adsorbent.

8. The CO₂ adsorptive material of claim 4, wherein the adsorbent material is any one of a poly(ethyleneimine), diethylenetriamine, an aminopropyl organosilane, tetraethylenepentamine, ethylenediamine, N,N′-dimethylethylenediamine, a poly(allylamine), a diethylenetriamino organosilane, a polyaziridine, a methylaminopropyl organosilane, or an ethylenediamine organosilane.)

9. The CO₂ adsorptive material of claim 4, wherein the CO₂ adsorptive material comprises a polymeric material.

10. The CO₂ adsorptive material of claim 9, wherein the polymeric material is any one of cellulose, cellulose acetate, a polyimide, a polyamide, a polyetherimide, a polyamide-imide, a polymer of intrinsic microporosity, a polysulfone, a polyethersulfone, or a polyvinylidene fluoride.

11. A carbon dioxide (CO₂) capture module comprising a CO₂ capture material according to claim 1.

12. The module of claim 11, wherein the module is a direct air capture (DAC) module.

13. The module of claim 11, wherein the module is a wind energy direct air capture (WEDAC) module.

14. The module of claim 13, wherein the module is configured to transition between an open configuration and a closed configuration, wherein
in the open configuration, the CO₂ adsorptive material is open to an external environment for adsorption of CO₂ from air in the external environment onto the CO₂ adsorbtive material, and
in the closed configuration, the CO₂ adsorptive material is isolated from the external environment for controlled desorption of the CO₂ from the CO₂ adsorptive material.

15. The module of claim 14, wherein the controlled desorption is vacuum-assisted and electrothermal.

16. A method removing CO₂ from a mixture of gases comprising:
transmitting the mixture of gases across a surface of a CO₂ capture material according to claim 1, and
removing CO₂ from the mixture of gases by adsorption of the CO₂ on the surface of the CO₂ capture material.

17. A method removing CO₂ from a mixture of gases comprising:
transmitting the mixture of gases through a CO₂ capture module according to claim 11. and
removing CO₂ from the mixture of gases by adsorption of the CO₂ on the surface of the CO₂ capture material.

18. The CO₂ adsorptive material of claim 2, wherein the CO₂ adsorptive material comprises a porous support and an adsorbent material.

19. The CO₂ adsorptive material of claim 3, wherein the CO₂ adsorptive material comprises a porous support and an adsorbent material.

20. The CO₂ adsorptive material of claim 5, wherein the adsorbent material is an amine-based adsorbent.
